(19) United States
(12) Patent Application Publication
(10) Pub. No.: US 2023/0141339 A1
(43) Pub. Date: May 11, 2023

(54) CARRIER AGGREGATION LIMIT FOR REL-16 PHYSICAL DOWNLINK CONTROL CHANNEL MONITORING CAPABILITIES

(71) Applicant: Telefonaktiebolaget LM Ericsson (publ), Stockholm (SE)

(72) Inventors: Kittipong Kittichokechai, JÄRFÄLLA (SE); Yufei Blankenship, KILDEER, IL (US); Mattias Andersson, SUNDBYBERG (SE); Jonas Fröberg Olsson, LJUNGSBRO (SE)

(21) Appl. No.: 17/914,966

(22) PCT Filed: Apr. 9, 2021
(86) PCT No.: PCT/SE2021/050325

§ 371 Date: Sep. 27, 2022

Related U.S. Application Data
(60) Provisional application No. 63/007,802, filed on Apr. 9, 2020.

(51) Int. Cl. H04W 72/51; H04W 72/1273; H04W 24/08; H04L 27/26

(52) U.S. Cl. CPC H04W 72/51; H04W 72/1273; H04W 24/08; H04L 27/26025

(57) ABSTRACT

Embodiments herein relate to for example a method performed by a network node for determining a carrier aggregation (CA) limit for UE configuration with monitoring capability, based on: a downlink (DL) sub-slot structure and/or pattern of a DL slot; a set of overlapping spans across scheduled cells; start and end times for spans across component carriers; and/or spans at least partially overlapping a CA limit window.

### TECHNICAL FIELD

The present disclosure relates generally to wireless communications networks, and more particularly to carrier aggregation for wireless communications.

### BACKGROUND

New radio (NR) standard in 3rd Generation Partnership Project (“3GPP”) is designed to provide service for multiple use cases such as enhanced mobile broadband (eMBB), ultra-reliable and low latency communication (URLLC), and machine type communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot is a concept that is used in scheduling and in downlink (DL) a min-slot can consist of 2, 4 or 7 orthogonal frequency division multiplexing (OFDM) symbols, while in uplink (UL) a mini-slot can be any number of 1 to 14 OFDM symbols. It should be noted that the concepts of slot and mini-slot are not specific to a specific service, meaning that a mini-slot may be used for either eMBB, URLLC, or other services. FIG. 1 illustrates example radio resources in NR.

URLLC has strict requirements on transmission reliability and latency, i.e., 99.9999% reliability within 1 ms one-way latency. In NR Rel-15, several new features were introduced to support these requirements. In release (Rel)-16, standardization works are focused on further enhancements. These include physical downlink control channel (PDCCH) enhancement to support increased PDCCH monitoring capability.

Below, a background description is provided regarding PDCCH monitoring in NR Rel-15 and some enhancements made in Rel-16.

CORESET configuration is initially explained below.

Control resource set, also called CORESET, are configured for UE via higher layer parameters. It provides structure for the resources to be used for PDCCH, e.g., resources in terms of the number of consecutive OFDM symbols and the set of resource blocks. In addition, it provides the type of control channel element (CCE)-to-resource element group (REG) mapping and transmission configuration indicator (TCI) state mapping for PDCCH beamforming. For each DL bandwidth part (BWP), multiple CORESETs can be configured to a UE.

3GPP TS 38.213, V16.1.0, section 10.1, reads as follows:
For each DL BWP configured to a UE in a serving cell, the UE can be provided by higher layer signalling with
   P≤3 CORESETs if CORESETPooIndex is not provided, or if a value of CORESETPoolIndex is same for all CORESETs if CORESETPoolIndex is provided
   P≤5 CORESETs if CORESETPoolIndex is not provided for a first CORESET, or is provided and has a value 0 for a first CORESET, and is provided and has a value 1 for a second CORESET
For each CORESET, the UE is provided the following by ControlResourceSet:
   a CORESET index p, by controlResourceSetId, where
      0≤p<12 if CORESETPoolIndex is not provided, or if a value of CORESETPoolIndex is same for all CORESETs if CORESETPoolIndex is provided;
      0<p<16 if CORESETPooIndex is not provided for a first CORESET, or is provided and has a value 0 for a first CORESET, and is provided and has a value 1 for a second CORESET;
   a DM-RS scrambling sequence initialization value by pdcch-DMRS-ScramblingID;
   a precoder granularity for a number of REGs in the frequency domain where the UE can assume use of a same DM-RS precoder by precoderGranularity;
   a number of consecutive symbols provided by duration;
   a set of resource blocks provided by frequencyDomainResources;
   CCE-to-REG mapping parameters provided by cce-REG-MappingType;
   an antenna port quasi co-location, from a set of antenna port quasi co-locations provided by TCI-State, indicating quasi co-location information of the DM-RS antenna port for PDCCH reception in a respective CORESET;
      if the UE is provided by simultaneousTCI-CellList a number of lists of cells for simultaneous TCI state activation, the UE applies the antenna port quasi co-location provided by TCI-States with same activated tci-StateID value to CORESETs with index p in all configured DL BWPs of all configured cells in a list determined from a serving cell index provided by a MAC CE command
   an indication for a presence or absence of a transmission configuration indication (TCI) field for a DCI format, other than DCI format 1_0, that schedules PDSCH receptions or indicates SPS PDSCH release and is transmitted by a PDCCH in CORESET p, by tci-PresentInDCI or tci-PresentInDCI-ForDCIFormat1_2.

Search space configuration is now explained below.

PDCCH search space sets are configured for UE via higher layer parameters. The UE performs blind decoding for a set of PDCCH candidates configured in search space (SS) sets. There can be up to 10 SS sets configured to a UE per DL BWP. Each SS set is associated with a certain CORESET and provides a UE with PDCCH monitoring occasions, number of PDCCH candidates for each aggregation level (AL), SS type (common or UE-specific), and downlink control information (DCI) formats to monitor.

3GPP TS 38.213, V16.1.0, section 10.1, reads as follows:
For each DL BWP configured to a UE in a serving cell, the UE is provided by higher layers with S≤10 search space sets where, for each search space set from the S search space sets, the UE is provided the following by SearchSpace:
   a search space set index s, 0<s<40, by searchSpaceId
   an association between the search space set s and a CORESET P by controlResourceSetId
   a PDCCH monitoring periodicity of kₛ slots and a PDCCH monitoring offset of oₛ slots, by monitoringSlotPeriodicityAndOffset
   a PDCCH monitoring pattern within a slot, indicating first symbol(s) of the CORESET within a slot for PDCCH monitoring, by monitoringSymbolsWithinSlot
   a duration of Tₛ<kₛ slots indicating a number of slots that the search space set s exists by duration
   a number of PDCCH candidates Mₛ^{(L)} per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively
   an indication that search space set s is either a CSS set or a USS set by searchSpaceType
   if search space set s is a CSS set
      an indication by dci-Format0-0-AndFormat1-0 to monitor PDCCH candidates for DCI format 0_0 and DCI format 1_0
      an indication by dci-Format2-0 to monitor one or two PDCCH candidates for DCI format 2_0 and a corresponding CCE aggregation level
      an indication by dci-Format2-1 to monitor PDCCH candidates for DCI format 2_1
      an indication by dci-Format2-2 to monitor PDCCH candidates for DCI format 2_2
      an indication by dci-Format2-3 to monitor PDCCH candidates for DCI format 2_3
      an indication by dci-Format2-4 to monitor PDCCH candidates for DCI format 2_4
      an indication by dci-Format2-6 to monitor PDCCH candidates for DCI format 2_6
   if search space set s is a USS set, an indication by dci-Formats to monitor PDCCH candidates either for DCI format 0_0 and DCI format 1_0, or for DCI format 0_1 and DCI format 1_1, or an indication by dci-Formats-Rel16 to monitor PDCCH candidates for DCI format 0_0 and DCI format 1_0, or for DCI format 0_1 and DCI format 1_1, or for DC format 0_2 and DCI format 1_2, or, if a UE indicates a corresponding capability, for DCI format 0_1, DCI format 1_1, DCI format 0_2, and DCI format 1_2, or for DCI format 3_0, or for DCI format 3_1, or for DCI format 3_0 and DCI format 3_1
   a bitmap by freqMonitorLocation-r16, if provided, to indicate one or more RB sets for the search space set s, where the MSB k in the bitmap corresponds to RB set k−1 in the DL BWP. For RB set k indicated in the bitmap, the first PRB of the frequency domain monitoring location confined within the RB set is given by N_{RB,set k}^{start}+N_{RB}^{offset}, where N_{RB,set k}^{start} is the index of first PRB of the RB set k, and N_{RB}^{offset} is provided by rb-offset or N_{RB}^{offset}=0 if rb-offset is not provided. The frequency domain resource allocation pattern for each monitoring location is determined based on the first N_{RBG,set 0}^{size} bits infrequencyDomainResources provided by the associated CORESET configuration.

PDCCH monitoring span is now explained below.

In NR Rel-15, there exist the definition of PDCCH monitoring span as part of the UE features.

The monitoring span imposes a constraint in terms of time gap between PDCCH monitoring throughout a slot. The UE capability signaling on PDCCH monitoring capability is in terms of minimum time separation between the start of two PDCCH monitoring spans (X) and maximum length of the spans (Y) as described in 3GPP TS 38.213, V16.1.0, Section 10, which reads as follows:
A UE reports one or more combinations of (X, Y) number of symbols, where X≥Y, for PDCCH monitoring. A span is a set of consecutive symbols in a slot in which the UE is configured to monitor PDCCH candidates. The UE supports PDCCH monitoring occasions in any symbol of a slot with minimum time separation of X symbols between the first symbol of two consecutive spans, including across slots. The duration of a span is dₛₚₐₙ=max(d_{CORESET,max}, Yₘᵢₙ), where d_{CORESET,max} is a maximum duration among durations of CORESETs that are configured to the UE and Yₘᵢₙ is a minimum value of Y in the combinations of (X, Y) that are reported by the UE. A last span in a slot can have a shorter duration than other spans in the slot.

In Rel-15, the supported value sets of combinations (X,Y) are also captured in Section 4.2.7.5 of 3GPP TS 38.306, V15.6.0 as part of the UE feature group 3-5b as shown below.

| | | | | |
|---|---|---|---|---|
| pdcch-MonitoringAnyOccasionsWithSpanGap | FS | No | No | No |
| Indicates whether the UE supports PDCCH search space monitoring | | | | |
| occasions in any symbol of the slot with minimum time separation between | | | | |
| two consecutive transmissions of PDCCH with span up to two OFDM symbols | | | | |
| for two OFDM symbols or span up to three OFDM symbols for four and seven | | | | |
| OFDM symbols. Value set1 indicates the supported value set (X, Y) is (7, 3), | | | | |
| value set2 indicates the supported value set (X, Y) is (4, 3) and (7, 3) and value | | | | |
| set 3 indicates the supported value set (X, Y) is (2, 2), (4, 3) and (7, 3). | | | | |

However, in Rel-16, the UE can report separately each combination (X,Y) from the set {(2,2), (4,3), (7,3)}.

The configured CORESETs and search spaces together with the reported combination (X,Y) then determines PDCCH monitoring span pattern in a slot. Clarification regarding the monitoring span pattern is given in the agreement made in RAN1 #96 bis below.

Agreements:

Update “Feature component” of FG 3-5b as below:
PDCCH monitoring occasions of FG-3-1, plus additional PDCCH monitoring occasion(s) can be any OFDM symbol(s) of a slot for Case 2, and for any two PDCCH monitoring occasions belonging to different spans, where at least one of them is not the monitoring occasions of FG-3-1, in same or different search spaces, there is a minimum time separation of X OFDM symbols (including the cross-slot boundary case) between the start of two spans, where each span is of length up to Y consecutive OFDM symbols of a slot. Spans do not overlap. Every span is contained in a single slot. The same span pattern repeats in every slot. The separation between consecutive spans within and across slots may be unequal but the same (X, Y) limit must be satisfied by all spans. Every monitoring occasion is fully contained in one span. In order to determine a suitable span pattern, first a bitmap b(l), 0<=l<=13 is generated, where b(l)=1 if symbol l of any slot is part of a monitoring occasion, b(l)=0 otherwise. The first span in the span pattern begins at the smallest l for which b(l)=1. The next span in the span pattern begins at the smallest l not included in the previous span(s) for which b(l)=1. The span duration is max {maximum value of all CORESET durations, minimum value of Y in the UE reported candidate value} except possibly the last span in a slot which can be of shorter duration. A particular PDCCH monitoring configuration meets the UE capability limitation if the span arrangement satisfies the gap separation for at least one (X, Y) in the UE reported candidate value set in every slot, including cross slot boundary.
For the set of monitoring occasions which are within the same span:
   Processing one unicast DCI scheduling DL and one unicast DCI scheduling UL per scheduled component carrier (CC) across this set of monitoring occasions for frequency division duplex (FDD)
   Processing one unicast DCI scheduling DL and two unicast DCI scheduling UL per scheduled CC across this set of monitoring occasions for time division duplex (TDD)
   Processing two unicast DCI scheduling DL and one unicast DCI scheduling UL per scheduled CC across this set of monitoring occasions for TDD
The number of different start symbol indices of spans for all PDCCH monitoring occasions per slot, including PDCCH monitoring occasions of FG-3-1, is no more than floor(14/X) (X is minimum among values reported by UE).
The number of different start symbol indices of PDCCH monitoring occasions per slot including PDCCH monitoring occasions of FG-3-1, is no more than 7.
The number of different start symbol indices of PDCCH monitoring occasions per half-slot including PDCCH monitoring occasions of FG-3-1 is no more than 4 in secondary cell (SCell).

In short, the PDCCH monitoring span definition provides a set of rules for UE and gNB to have the same understanding on PDCCH monitoring span pattern in a slot based on CORESET/search space configuration and UE capability signaling {(X,Y)} related to PDCCH monitoring. The UE signals one or more candidate values which are parameters related to span gap X (minimum gap in OFDM symbols between two consecutive spans) and span length Y in OFDM symbols. Together with the CORESET/search space configuration, the monitoring span pattern can then be derived. The span pattern which may contain multiple spans in a slot is repeated over multiple slots. In Rel-15, three candidate values (X,Y) are defined, namely (X,Y)=(7,3), (4,3), and (2,2). When UE reports the candidate values, it reports a candidate value set which contains nested candidate values. Three possible candidate value sets are {(7,3)}, {(4,3), (7,3)}, and {(2,2), (4,3), (7,3)} which support up to 2, 3, and 7 monitoring spans in a slot, respectively. In Rel-16, UE can report its capability of the supported combination (X, Y) separately unlike in Rel-15 where the candidate value set contains nested candidate values.

Some examples of PDCCH monitoring span pattern determined from CORESET/search space configuration and UE monitoring capability reporting (X,Y) are shown in FIG. 2 where the shaded blocks represent PDCCH monitoring occasions configured in search spaces. Note that since the span pattern is repeated in every slot, some spans might not have any actual PDCCH monitoring occasion. More particularly, FIG. 2 illustrates examples of PDCCH monitoring span patterns, where (a) corresponds to a span length=max{max CORESET, min Y}=max{2,2}=2, (b) corresponds to a span length=max{2,3}=3, and (c) corresponds to a span length=max{2,3}=3.

FIG. 3 and FIG. 4 illustrate examples of PDCCH monitoring spans derived from different search space configurations containing different PDCCH monitoring occasions over multiple slots. They lead to different monitoring span patterns even though the UE reports the same capability (X,Y)=(4,3). FIG. 3 illustrates PDCCH monitoring span for UE reported capability (X,Y)=(4,3). FIG. 4 illustrates PDCCH monitoring span for UE reported capability (X,Y)=(4,3).

PDCCH monitoring capability in terms of maximum number of monitored PDCCH candidates (blind decodes) and non-overlapped CCEs for channel estimation, is now described below.

PDCCH monitoring capability is described by the maximum number of blind decodes/monitored PDCCH candidates per slot or per monitoring span and the maximum number of non-overlapped CCEs for channel estimation per slot or per monitoring span. The limits per slot may be referred to as associated with Rel-15 PDCCH monitoring capability, while the limits per span may be referred to as associated with Rel-16 PDCCH monitoring capability. A UE is configured per serving cell which PDCCH monitoring capability to follow by the higher parameter.

3GPP TS 38.213, V16.1.0, section 10, reads as follows:
A UE monitors a set of PDCCH candidates in one or more CORESETs on the active DL BWP on each activated serving cell configured with PDCCH monitoring according to corresponding search space sets where monitoring implies decoding each PDCCH candidate according to the monitored DCI formats.
If a UE is provided PDCCHMonitoringCapabilityConfig for a serving cell, the UE obtains an indication to monitor PDCCH on the serving cell for a maximum number of PDCCH candidates and non-overlapped CCEs
   per slot, as in Tables 10.1-2 and 10.1-3, if PDCCHMornitoringCapabilityConfig=R15 PDCCH monitoring capability, or
   per span, as in Tables 10.1-2A and 10.1-3A, if PDCCHMornitoringCapabilityConfig=R16 PDCCH monitoring capability
If the UE is not provided PDCCHMonitoringCapabilityConfig, the UE monitors PDCCH on the serving cell per slot.

The maximum numbers or limits per slot or per span are defined in 3GPP TS 38.213, V16.1.0, Section 10.1 for a single serving cell as a function of subcarrier spacing values for the slot limit and as a function of subcarrier spacing (SCS) and combination (X,Y) for the span limit (also shown in the tables below). Note that the values for the span limits are still under discussion and only included in the current version of the specifications as place holders.

Table 10.1-2 of 3GPP TS 38.213, V16.1.0 provides the maximum number of monitored PDCCH candidates, M_{PDCCH}^{max,slot,μ}, per slot for a UE in a DL BWP with SCS configuration μ for operation with a single serving cell, as follows

| | Maximum number of monitored |
|---|---|
| | PDCCH candidates per |
| | slot and per serving cell |
| μ | M_{PDCCH}^{max, slot, μ} |
| 0 | 44 |
| 1 | 36 |
| 2 | 22 |
| 3 | 20 |

Table 10.1-2A provides the maximum number of monitored PDCCH candidates, M_{PDCCH}^{max,(X,Y),μ}, per span for a UE in a DL BWP with SCS configuration μ for operation with a single serving cell, as follows:

| | Maximum number | | |
|---|---|---|---|
| | M_{PDCCH}^{max, (X, Y), μ} of monitored | | |
| | PDCCH candidates per | | |
| | span for combination | | |
| | (X, Y) and per serving cell | | |
| μ | (2, 2) | (4, 3) | (7, 3) |
| 0 | M01 | M02 | M03 |
| 1 | M11 | M12 | M13 |

Table 10.1-3 provides the maximum number of non-overlapped CCEs, C_{PDCCH}^{max,slot,μ}, for a DL BWP with SCS configuration P that a UE is expected to monitor corresponding PDCCH candidates per slot for operation with a single serving cell.

CCEs for PDCCH candidates are non-overlapped if they correspond to
different CORESET indexes, or
different first symbols for the reception of the respective PDCCH candidates.

Table 10.1-3 reads as follows:

| | Maximum number of |
|---|---|
| | non-overlapped CCEs |
| | per slot and per |
| | serving cell |
| μ | C_{PDCCH}^{max, slot, μ} |
| 0 | 56 |
| 1 | 56 |
| 2 | 48 |
| 3 | 32 |

Table 10.1-3A provides the maximum number of non-overlapped CCEs, C_{PDCCH}^{max,(X,Y),μ}, for a DL BWP with SCS configuration μ that a UE is expected to monitor corresponding PDCCH candidates per span for operation with a single serving cell. Table 10.1-3A reads as follows:

| | Maximum number C_{PDCCH}^{max, (X, Y), μ} | | |
|---|---|---|---|
| | of non-overlapped CCEs | | |
| | per span for | | |
| | combination (X, Y) | | |
| | and per serving cell | | |
| μ | (2, 2) | (4, 3) | (7, 3) |
| 0 | C01 | C02 | 56 |
| 1 | C11 | C12 | 56 |

A UE can indicate a capability to monitor PDCCH according to one or more of the combinations (X, Y)=(2, 2), (4, 3), and (7, 3) per SCS configuration of μ=0 and μ=1. If the UE indicates a capability to monitor PDCCH according to multiple (X, Y) combinations and a configuration of search space sets to the UE for PDCCH monitoring on a cell results to a separation of every two consecutive PDCCH monitoring spans that is equal to or larger than the value of X for two or more of the multiple combinations (X, Y), the UE is expected to monitor PDCCH on the cell according to the combination (X, Y) associated with the largest maximum number of C_{PDCCH}^{max,(X,Y),μ} and M_{PDCCH}^{max,(X,Y),μ}.

PDCCH monitoring capability for carrier aggregation (CA) case is now explained below.

It was agreed in RAN1 #99 that UE can report its PDCCH monitoring capability for the CA case in different ways. Case 1 below corresponds to the case where the UE reports the number of component carriers (CC) all with Rel-15 monitoring capability (limits for BD and non-overlapped CCEs per slot). Case 2 corresponds to the case where the UE reports the number of component carriers (CC) all with Rel-16 monitoring capability (limits for BD and non-overlapped CCEs per span). Lastly, Case 3 corresponds to the case where the UE reports both the number of component carriers (CC) with Rel-15 and Rel-16 monitoring capability on different serving cells. The agreement reads as follows:

Agreement

UE reports its PDCCH monitoring capability for the following cases:
Case 1: Capability on the number of CCs with Rel-15 monitoring capability only
   This capability already exists in Rel-15
Case 2: Capability on the number of CCs with Rel-16 monitoring capability only
   pdcch-BlindDetectionCA-R16 can be smaller than 4
Case 3: Capability on the number of CCs with Rel-15 monitoring capability and Rel-16 monitoring capability on different serving cells
   pdcch-BlindDetectionCA-R15 for Rel-15 PDCCH monitoring capability
   pdcch-BlindDetectionCA-R16 for Rel-16 PDCCH monitoring capability
      Each of pdcch-BlindDetectionCA-R16 and pdcch-BlindDetectionCA-R15 can be smaller than 4
      (The minimum of pdcch-BlindDetectionCA-R15+The minimum of pdcch-BlindDetectionCA-R16) is not larger than 4
         FFS (the minimum of pdcch-BlindDetectionCA-R15+the minimum of pdcch-BlindDetectionCA-R16) can be smaller than 4
pdcch-BlindDetectionCA-R15 and pdcch-BlindDetectionCA-R16 for the above three cases can be reported separately

It is noted that Case 1 is the same as the existing Rel-15 capability. For Case 2 and Case 3, the above agreements are captured in the specification 3GPP TS 38.213, V16.1.0, in Section 10 as shown below.
If a UE indicates in UE-NR-Capability-r16 a carrier aggregation capability larger than X downlink cells, the UE includes in UE-NR-Capability-r16 an indication for a maximum number of PDCCH candidates and a maximum number of non-overlapped CCEs that the UE can monitor per span when the UE is configured for carrier aggregation operation over more than X downlink cells. When a UE is not configured for NR-DC operation and the UE is provided PDCCHMonitoringCapabilityConfig=R16 PDCCH monitoring capability for all downlink cell where the UE monitors PDCCH, the UE determines a capability to monitor a maximum number of PDCCH candidates and a maximum number of non-overlapped CCEs per span that corresponds to N_{cells}^{cap-r16} downlink cells, where
   N_{cells}^{cap-r16} is the number of configured downlink cells if the UE does not provide pdcch-BlindDetectionCA-r16
   otherwise, N_{cells}^{cap-r16} is the value of pdcch-BlindDetectionCA-r16
If a UE indicates in UE-NR-Capability-r15 or in UE-NR-Capability-r16 a carrier aggregation capability larger than Y downlink cells or larger than Z downlink cells, respectively, the UE includes in UE-NR-Capability-r15 or in UE-NR-Capability-r16 an indication for a maximum number of PDCCH candidates and a maximum number of non-overlapped CCEs the UE can monitor for downlink cells with PDCCHMonitoringCapabilityConfig=R15 PDCCH monitoring capability or for downlink cells with PDCCHMonitoringCapabilityConfig=R16 PDCCH monitoring capability when the UE is configured for carrier aggregation operation over more than Y downlink cells or over more than Z downlink cells, respectively, and with at least one downlink cells from the Y downlink cells and at least one downlink cell from the Z downlink cells. When a UE is not configured for NR-DC operation, the UE determines a capability to monitor a maximum number of PDCCH candidates and a maximum number of non-overlapped CCEs per slot or per span that corresponds to N_{cells,r15}^{cap-r16} downlink cells or to N_{cells,r16}^{cap-r16} downlink cells, respectively, where
   N_{cells,r15}^{cap-r16} is the number of configured downlink cells if the UE does not provide pdcch-BlindDetectionCA-r15
   otherwise, N_{cells,r15}^{cap-r16} is the value of pdcch-BlindDetectionCA-r15
and
   N_{cells,r16}^{cap-r16} is the number of configured downlink cells if the UE does not provide pdcch-BlindDetectionCA-r16
   otherwise, N_{cells,r16}^{cap-r16} is the value of pdcch-BlindDetectionCA-r16

PDCCH monitoring capabilities (slot or span limits) defined in the previous section can be referred to as a per-component carrier (CC) or single-serving cell limit. For the case of carrier aggregation (CA), the CA-capability is determined based on the UE reported capability on the number of serving cells it is capable of monitoring and the number of configured serving cells.

If the UE is capable of monitoring a greater number of cells than what it is configured for, PDCCH monitoring capability per cell would simply correspond to the per-CC limit defined in the previous section.

However, if the UE reports its capability in terms of the number of cells to be a lower number than the number of configured serving cells, the CA-limit is applied across cells or CCs. The CA-limit is a total limit of maximum number of blind decodes or non-overlapped CCEs to be applied per slot across CCs or to be applied for a set of spans across CCS. It is derived by proportionally scaling down the value based on the number of configured serving cells.

The CA limit (M_{PDCCH}^{total,slot,μ} and C_{PDCCH}^{total,slot,μ}) corresponding to Rel-15 PDCCH monitoring capability is described in 3GPP TS 38.213, V16.1.0, Section 10.1, which reads as follows:
If a UE
   does not report pdcch-BlindDetectionCA or is not provided BDFactorR, γ=R
   reports pdcch-BlindDetectionCA, the UE can be indicated by BDFactorR either γ=1 or γ=R
If a UE is configured with N_{cells,0}^{DL,μ}+N_{cells,1}^{DL,μ} downlink cells with associated PDCCH candidates monitored in the active DL BWPs of the scheduling cell(s) using SCS configuration μ where Σ_{μ=0}³(N_{cells,0}^{DL,μ}+γ·N_{cells,1}^{DL,μ})≤N_{cells}^{cap}, the UE is not required to monitor, on the active DL BWP of the scheduling cell,
   more than M_{PDCCH}^{total,slot,μ}=M_{PDCCH}^{max,slot,μ} PDCCH candidates or more than C_{PDCCH}^{total,slot,μ}=C_{PDCCH}^{max,slot,μ} non-overlapped CCEs per slot for each scheduled cell when the scheduling cell is from the N_{cells,0}^{DL,μ} downlink cells, or
   more than M_{PDCCH}^{total,slot,μ}=γ·M_{PDCCH}^{max,slot,μ} PDCCH candidates or more than C_{PDCCH}^{total,slot,μ}=γ·C_{PDCCH}^{max,slot,μ} non-overlapped CCEs per slot for each scheduled cell when the scheduling cell is from the N_{cells,1}^{DL,μ} downlink cells
   more than M_{PDCCH}^{max,slot,μ} PDCCH candidates or more than C_{PDCCH}^{max,slot,μ} non-overlapped CCEs per slot for CORESETs with same CORESETPoolIndex value for each scheduled cell when the scheduling cell is from the N_{cells,1}^{DL,μ} downlink cells
If a UE is configured with N_{cells,0}^{DL,μ}+N_{cells,1}^{DL,μ} downlink cells using Rel-15 PDCCH monitoring capability and with associated PDCCH candidates monitored in the active DL BWPs of the scheduling cell(s) using SCS configuration μ, where Σ_{μ=0}³=(N_{cells,0}^{DL,μ}+γ·N_{cells,1}^{DL,μ})>N_{cells}^{cap}, a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than M_{PDCCH}^{total,slot,μ}= [symbol] N_{cells}^{cap}·M_{PDCCH}^{max,slot,μ}·(N_{cells,0}^{DL,μ}+γ·N_{cells,1}^{DL,μ})/Σⱼ₌₀³(N_{cells,0}^{DL,j}+γ·N_{cells,1}^{DL,j}) [symbol] PDCCH candidates or more than C_{PDCCH}^{total,slot,μ}= [symbol] N_{cells}^{cap}·C_{PDCCH}^{max,slot,μ}·(N_{cells,0}^{DL,μ}+γ·N_{cells,1}^{DL,μ})/Σⱼ₌₀³(N_{cells,0}^{DL,j}+γ·N_{cells,1}^{DL,j}) [symbol] non-overlapped CCEs per slot on the active DL BWP(s) of scheduling cell(s) from the N_{cells,0}^{DL}+N_{cells,1}^{DL} downlink cells. If a UE is configured with downlink cells using both Rel-15 PDCCH monitoring capability and Rel-16 PDCCH monitoring capability, N_{cells}^{cap} is replaced by N_{cells,r15}^{cap-r16}.
For each scheduled cell, the UE is not required to monitor on the active DL BWP with SCS configuration μ of the scheduling cell from the N_{cells,0}^{DL,μ} downlink cells more than min(M_{PDCCH}^{max,slot,μ}, M_{PDCCH}^{total,slot,μ}) PDCCH candidates or more than min(C_{PDCCH}^{max,slot,μ}, C_{PDCCH}^{total,slot,μ}) non-overlapped CCEs per slot.
For each scheduled cell, the UE is not required to monitor on the active DL BWP with SCS configuration μ of the scheduling cell from the N_{cells,1}^{DL,μ} downlink cells
   more than min(γ·M_{PDCCH}^{max,slot,μ}, M_{PDCCH}^{total,slot,μ}) PDCCH candidates or more than min(γ·C_{PDCCH}^{max,slot,μ}, C_{PDCCH}^{total,slot,μ}) non-overlapped CCEs per slot
   more than min(M_{PDCCH}^{max,slot,μ}, M_{PDCCH}^{total,slot,μ}) PDCCH candidates or more than min(C_{PDCCH}^{max,slot,μ}, C_{PDCCH}^{total,slot,μ}) non-overlapped CCEs per slot for CORESETs with same CORESETPoolIndex value.

For Rel-16, the CA limit (M_{PDCCH}^{total,(X,Y),μ} and C_{PDCCH}^{total,(X,Y),μ}) corresponding to Rel-16 PDCCH monitoring capability is described in 3GPP TS 38.213, V16.1.0, Section 10.1, which reads as follows:
If a UE is configured only with N_{cells,r16}^{DL,μ} downlink cells using Rel-16 PDCCH monitoring capability, and with N_{cells,r16}^{DL,(X,Y),μ} of the N_{cells,r16}^{DL,μ} downlink cells using combination (X, Y) for PDCCH monitoring, and having active DL BWPs using SCS configuration μ, where Σ_{μ=0}¹N_{cells,r16}^{DL,μ}>N_{cells}^{cap-r16}, a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than M_{PDCCH}^{total,(X,Y),μ}= [symbol] N_{cells}^{cap-r16}. M_{PDCCH}^{max,(X,Y),μ}·N_{cells,r16}^{DL,(X,Y),μ}/Σⱼ₌₀¹N_{cells,r16}^{DL,j} [symbol] PDCCH candidates or more than C_{PDCCH}^{total,(X,Y),μ}= [symbol] N_{cells}^{cap-r16}·C_{PDCCH}^{max,(X,Y),μ}·N_{cells,r16}^{DL,(X,Y),μ}/Σⱼ₌₀¹N_{cells,r16}^{DL,j} [symbol] non-overlapped CCEs per span on the active DL BWP(s) of scheduling cell(s) from the N_{cells,r16}^{DL,(X,Y),μ} downlink cells if the spans on all scheduling cells from the N_{cells,r16}^{DL,(X,Y),μ} downlink cells are aligned, where N_{cells,r16}^{DL,j} is a number of configured cells using Rel-16 PDCCH monitoring capability with SCS configuration j. If a UE is configured with downlink cells using both Rel-15 PDCCH monitoring capability and Rel-16 PDCCH monitoring capability, N_{cells}^{cap-r16} is replaced by N_{cells,r16}^{cap-r16}.

It is noted that the description above for the Rel-16 CA limit only applies to the case where the spans on all scheduling cells from the N_{cells,r16}^{(DL,(X,Y),μ} downlink cells are aligned. The total limits for PDCCH candidates and non-overlapped CCEs, i.e., M_{PDCCH}^{total,(X,Y),μ} and C_{PDCCH}^{total,(X,Y),μ} are then applied per span on the active DL BWP(s) of scheduling cell(s) from the N_{cells,r16}^{DL,(X,Y),μ} downlink cells.

One example of the aligned spans across the downlink cells is given in FIG. 5 where there are 5 downlink cells using combination (X,Y)=(2,2) for PDCCH monitoring. For example, in this case, the CA limit, M_{PDCCH}^{total,(2,2),μ} is simply the total limit for the maximum number of blind decodes summed across the 5 CCs per span illustrated by the dashed circle.

FIG. 5 illustrates PDCCH monitoring span aligned on all 5 downlink cells.

On the other hand, FIG. 6 shows an example of the spans which are not aligned across the downlink cells. In this case, there are 2 downlink cells using combination (X,Y)=(2,2) for PDCCH monitoring. In FIG. 6, PDCCH monitoring span is not aligned across the 2 downlink cells.

### SUMMARY

Various of the following embodiments in the present disclosure may overcome a limitation in which the current version of the NR specifications (e.g. 3GPP TS 38.213, V16.1.0) only describes the Rel-16 CA limit per span for the case where the spans on all scheduling cells are aligned. These embodiments may provide a solution to determine the CA limit for other cases (e.g., non-aligned spans). The following embodiments are directed to providing multiple solutions for determining the Rel-16 CA limit when the UE is configured with PDCCH monitoring capability according to the Rel-16 monitoring capability. The solutions are unified solutions in the sense that they can be applied regardless of whether the spans on all scheduling cells from the N_{cells,r16}^{DL,(X,Y),μ} downlink cells are aligned or not. Thus, an object of embodiments herein is to provide a mechanism for monitoring a PDCCH in an efficient and reliable manner.

According to an aspect the object is achieved by providing a method performed by a network node. The network node determines a CA limit for UE configuration with monitoring capability, based on: a DL-sub-slot structure and/or pattern of a DL slot; a set of overlapping spans across scheduling cells; start and end times for spans across component carriers; and/or spans at least partially overlapping a CA limit window.

According to another aspect the object is achieved by providing a method performed by a UE. The UE, during PDCCH monitoring, drops a PDCCH candidate when a total number of configured PDCCH candidates or non-overlapped CCEs, in a set of spans on a primary cell or primary secondary cell exceeds a per-span limit or exceeds a CA limit.

According to yet another aspect the object is achieved by providing a network node. The network node is configured to determine a CA limit for UE configuration with monitoring capability, based on: a DL-sub-slot structure and/or pattern of a DL slot; a set of overlapping spans across scheduling cells; start and end times for spans across component carriers; and/or spans at least partially overlapping a CA limit window.

According to still another aspect the object is achieved by providing a UE. The UE is configured to, during PDCCH monitoring, drop a PDCCH candidate when a total number of configured PDCCH candidates or non-overlapped CCEs, in a set of spans on a primary cell or primary secondary cell exceeds a per-span limit or exceeds a CA limit.

It is furthermore provided herein a computer program product comprising instructions, which, when executed on at least one processor, cause the at least one processor to carry out the method above, as performed by the network node, and the UE, respectively.

One embodiment is directed to a method by a network node that includes determining a CA limit for UE configuration with monitoring capability, based on: a DL-sub-slot structure and/or pattern of a DL slot.

Another embodiment is directed to a method by a network node that includes determining a CA limit for UE configuration with monitoring capability, based on a set of overlapping spans across scheduled cells.

Another embodiment is directed to a method by a UE that includes during PDCCH monitoring, dropping a PDCCH candidate when a total number of configured PDCCH candidates or non-overlapped control channel elements (CCEs) in a set of spans on a primary cell or primary secondary cell exceeds a per-span limit or exceeds a CA limit.

Another embodiment is directed to a method by a network node that includes determining a CA limit for UE configuration with monitoring capability, based on adjacent DL-sub-slot structures and/or patterns of adjacent DL slots.

Another embodiment is directed to a method by a network node that includes determining a CA limit for UE configuration with monitoring capability, based on start and end times for spans across component carriers.

Another embodiment is directed to a method by a network node that includes determining a CA limit for UE configuration with monitoring capability, based on spans at least partially overlapping a CA limit window, wherein the CA limit window is based on a start of a slot.

Another embodiment is directed to a method by a network node that includes determining a CA limit for UE configuration with monitoring capability, based on spans at least partially overlapping a CA limit window, wherein the CA limit window is determined for each subcarrier spacing (SCS) p based on all component carriers.

Another embodiment is directed to a method by a network node that includes determining a CA limit for UE configuration with monitoring capability, based on spans at least partially overlapping a CA limit window which extends across a slot boundary.

Other embodiments are directed to corresponding network nodes and UEs.

One embodiment is directed to a network node configured to determine a CA limit for UE configuration with monitoring capability, based on a DL-sub-slot structure and/or pattern of a DL slot.

Another embodiment is directed to a network node configured to determine a CA limit for UE configuration with monitoring capability, based on a set of overlapping spans across scheduled cells.

Another embodiment is directed to a UE configured to during PDCCH monitoring, drop a PDCCH candidate when a total number of configured PDCCH candidates or non-overlapped CCEs in a set of spans on a primary cell or primary secondary cell exceeds a per-span limit or exceeds a CA limit.

Another embodiment is directed to a network node configured to determine a CA limit for UE configuration with monitoring capability, based on adjacent DL-sub-slot structures and/or patterns of adjacent DL slots.

Another embodiment is directed to a network node configured to determine a CA limit for UE configuration with monitoring capability, based on start and end times for spans across component carriers.

Another embodiment is directed to a network node configured to determine a CA limit for UE configuration with monitoring capability, based on spans at least partially overlapping a CA limit window, wherein the CA limit window is based on a start of a slot.

Another embodiment is directed to a network node configured to determine a CA limit for UE configuration with monitoring capability, based on spans at least partially overlapping a CA limit window, wherein the CA limit window is determined for each subcarrier spacing (SCS) p based on all component carriers.

Another embodiment is directed to a network node configured to determine a CA limit for UE configuration with monitoring capability, based on spans at least partially overlapping a CA limit window which extends across a slot boundary.

Embodiments herein are applicable regardless of whether the spans on all scheduling cells from the N_{cells,r16}^{DL,(X,Y),μ} downlink cells are aligned or not. Thus, embodiments herein provide a mechanism for monitoring a PDCCH in an efficient and reliable manner.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates example radio resources in NR;

FIG. 2 illustrates examples of PDCCH monitoring span patterns;

FIGS. 3 and 4 illustrate examples of PDCCH monitoring spans derived from different search space configurations containing different PDCCH monitoring occasions over multiple slots;

FIG. 5 illustrates PDCCH monitoring span aligned on all 5 downlink cells;

FIG. 6 shows an example of the spans which are not aligned across the downlink cells;

FIG. 7a illustrates a method performed by a network node according to embodiments herein;

FIG. 7b illustrates a method performed by a UE according to embodiments herein;

FIG. 7c illustrates an example of DL-sub-slot pattern determination according to an embodiment of the present disclosure;

FIG. 8 illustrates one example of DL-sub-slot structures/patterns for different combinations (X,Y) according to an embodiment of the present disclosure;

FIG. 9 illustrates an example of the sets of spans determined according to an embodiment of the present disclosure;

FIGS. 10-13 illustrates examples the sets of spans determined according to some embodiments of the present disclosure;

FIG. 14 shows example sets of overlapped spans across DL cells according to some embodiments of the present disclosure;

FIG. 15 shows example sets of overlapped spans according to some embodiments of the present disclosure;

FIG. 16 shows example sets of overlapped spans across DL cells, where the non-overlapped span is excluded from any set of overlapped spans according to some embodiments of the present disclosure;

FIG. 17 shows example sets of overlapped spans according to some embodiments of the present disclosure;

FIG. 18 shows DL-sub-slot structure/pattern for each combination (X,Y) for the purpose of determining Rel-16 CA limit where adjacent DL-sub-slots can overlap, according to some embodiments of the present disclosure;

FIG. 19 shows an example of determining time partitions based on start and end times for spans across the component carriers, according to some embodiments of the present disclosure;

FIG. 20 shows an example of determining spans that shall obey CA limit based on CA-limit window according to some embodiments of the present disclosure;

FIG. 21 shows an example of time partitions when spans are with different span combination according to some embodiments of the present disclosure;

FIG. 22 shows an example CA-limit window when spans are with different span combination according to some embodiments of the present disclosure;

FIGS. 23 and 24 illustrate two examples of locations of CA-limit where a set of spans in different slots overlaps the CA-limit window and shall obey the CA limit according to some embodiments of the present disclosure;

FIGS. 25, 26, and 28-32 are flowcharts of operations by network node in accordance with some embodiments of the present disclosure;

FIG. 27 is a flowchart of operations by UE in accordance with some embodiments of the present disclosure.

FIG. 33 is a block diagram illustrating a UE (communication device) in accordance with some embodiments of the present disclosure;

FIG. 34 is a block diagram illustrating a radio access network node in accordance with some embodiments of the present disclosure;

FIG. 35 is a block diagram illustrating a network node in accordance with some embodiments of the present disclosure;

FIG. 36 is a block diagram of a wireless network in accordance with some embodiments;

FIG. 37 is a block diagram of another communication device, e.g., another UE in accordance with some embodiments;

FIG. 38 is a block diagram of a virtualization environment in accordance with some embodiments;

FIG. 39 is a block diagram of a telecommunication network connected via an intermediate network to a host computer in accordance with some embodiments;

FIG. 40 is a block diagram of a host computer communicating via a base station with a user equipment over a partially wireless connection in accordance with some embodiments;

FIG. 41 is a block diagram of methods implemented in a communication system including a host computer, a base station and a user equipment in accordance with some embodiments;

FIG. 42 is a block diagram of methods implemented in a communication system including a host computer, a base station and a user equipment in accordance with some embodiments;

FIG. 43 is a block diagram of methods implemented in a communication system including a host computer, a base station and a user equipment in accordance with some embodiments; and

FIG. 44 is a block diagram of methods implemented in a communication system including a host computer, a base station and a user equipment in accordance with some embodiments.

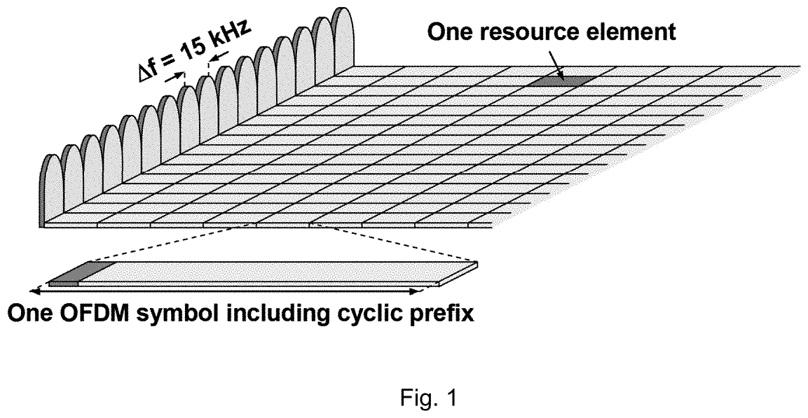

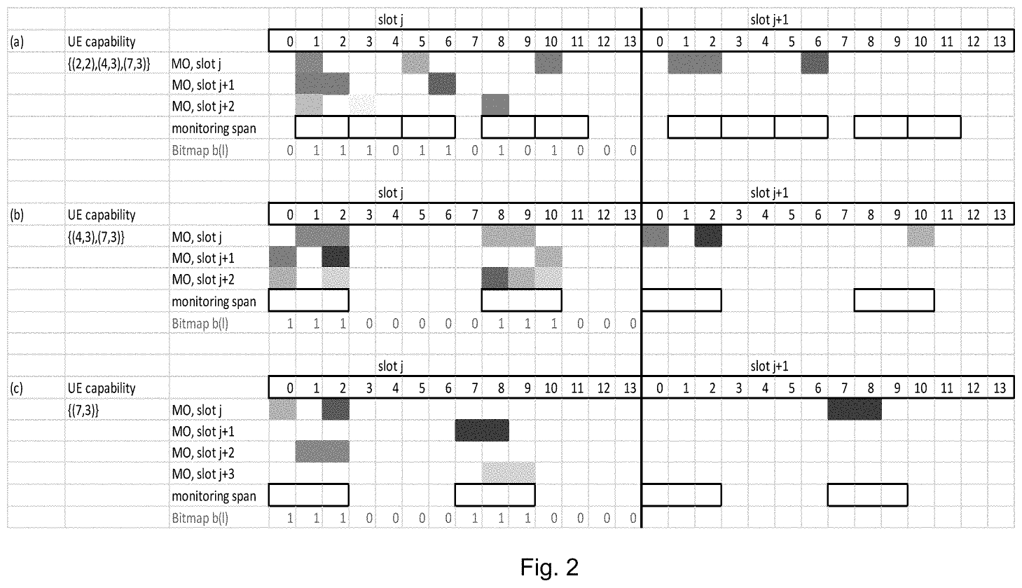

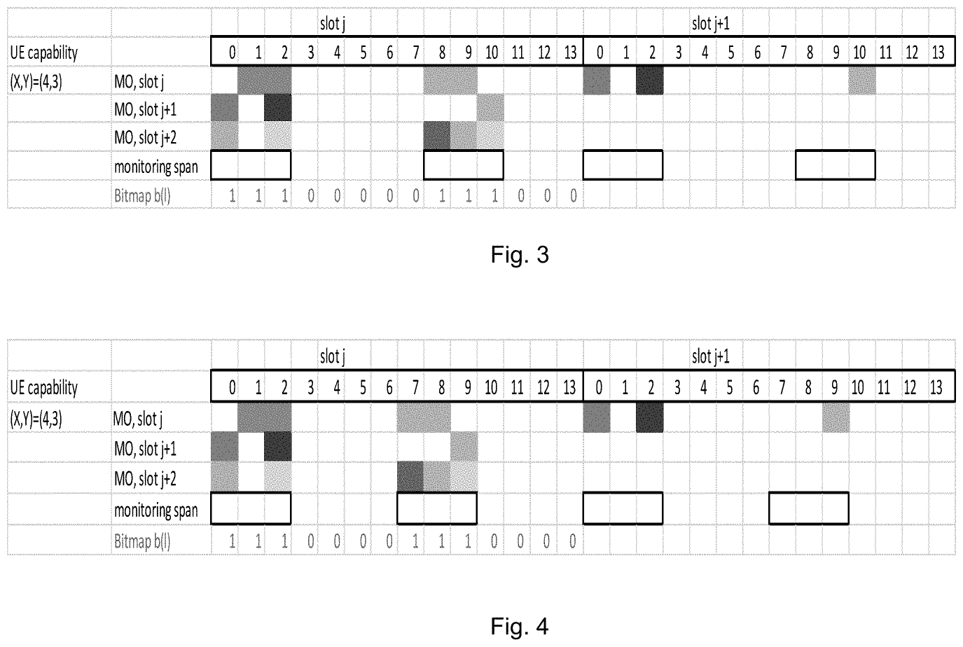

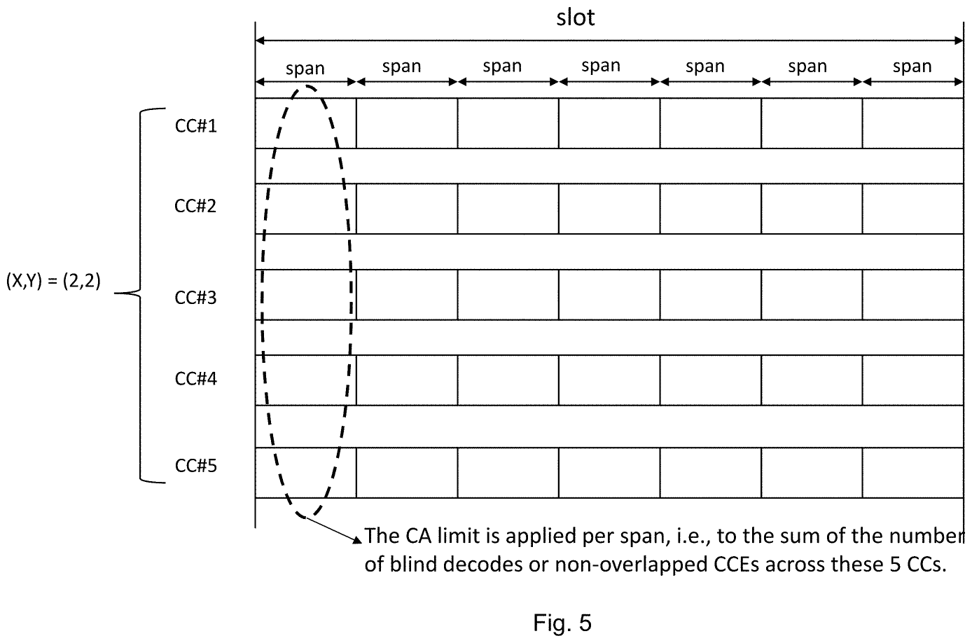

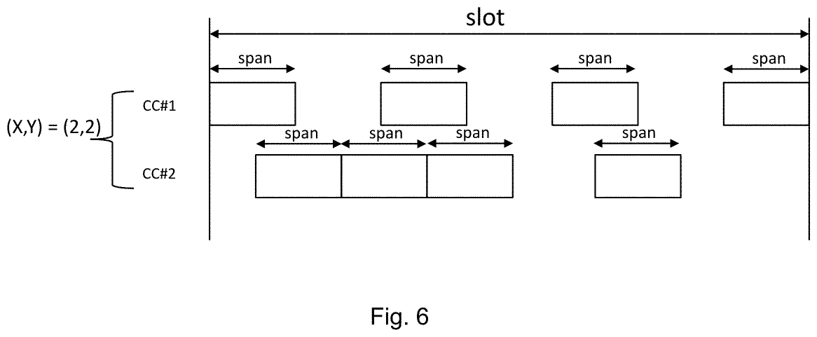

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Some embodiments of the present disclosure may arise from the present realization that the current version of the NR specifications (e.g. 3GPP TS 38.213, V16.1.0) only describe the Rel-16 CA limit per span for the case where the spans on all scheduling cells are aligned. A solution to determine the CA limit for other cases (e.g., non-aligned spans) is still missing. It is unclear how the CA limit would be applied when the spans are not aligned across component carriers using Rel-16 PDCCH monitoring capability associated with the same combination (X,Y).

Some embodiments of the present disclosure are directed to providing multiple solutions for determining the Rel-16 CA limit when the UE is configured with PDCCH monitoring capability according to the Rel-16 monitoring capability. The solutions are unified solutions in the sense that they can be applied regardless of whether the spans on all scheduling cells from the N_{cells,r16}^{DL,(X,Y),μ} downlink cells are aligned or not.

In case that the spans on all scheduling cells from the N_{cells,r16}^{DL,(X,Y),μ} downlink cells are aligned, the solutions provide the exact same CA limit as the one currently specified for the aligned span case.

Some embodiments of the present disclosure may be based on the following principles:
1) Introduction of DL-sub-slot structure for the purpose of Rel-16 CA limit determination; and
2) Principle of Rel-16 CA limit determination based on the DL-sub-slot structure

In addition, these embodiments may provide a solution for Rel-16 CA limit determination based on overlapped spans.

Accordingly, one or more embodiments of the present disclosure may provide a complete and unified solution for determining the CA limit for UE configured with Rel-16 monitoring capability.

The terms DL cell, scheduled cell, scheduling cell, serving cell, component carrier (CC) can be used interchangeably in the following description of PDCCH monitoring capability for carrier aggregation (CA) case.

The description provided below is based on single transmission reception point (TRP) transmission. The extension to the case of multi-TRP transmission can be done where the number of DL cells are considered for different TRPs.

Solutions for CA-limit determination based on the concept of DL-sub-slot are described below regarding a Section 1.1 titled “DL-sub-slot pattern/structure for the purpose of Rel-16 CA limit determination” and Section 5.0 titled “DL-sub-slot structure considering UE monitoring limit between two adjacent DL-sub-slots.”

Section 1.0 titled “DL-sub-slot pattern/structure for the purpose of Rel-16 CA limit determination” is described below.

In the following descriptions of a structure within a slot, the term DL-sub-slot, i.e., a downlink slot may be considered as comprises or includes multiple DL-sub-slots. In this discussion, the DL-sub-slot is defined for PDCCH monitoring, thus the DL-sub-slot is defined using DL carrier numerology (e.g., the DL SCS). The DL-sub-slot should be differentiated from the uplink sub-slot defined for PUCCH transmission, which uses UL carrier numerology, and the DL and UL carrier numerology may or may not be the same. The term DL-sub-slot is only exemplary and can be replaced by other terms of the same underlying meaning.

For a given configuration, the DL slot is composed of two or more DL-sub-slots, where the two or more DL-sub-slots may have the same duration or different duration. Here the configuration includes parameter settings such as SCS, combination (X,Y), and the number of component carriers configured with Rel-16 PDCCH monitoring.

For the purpose of determining Rel-16 PDCCH monitoring capability for the carrier aggregation case, let a UE be configured with N_{cells,r16}^{DL,μ} downlink cells using Rel-16 PDCCH monitoring capability, and with N_{cells,r16}^{DL,(X,Y),μ} of the N_{cells,r16}^{DL,μ} downlink cells using combination (X,Y) for PDCCH monitoring, and having active DL BWP(s) using SCS configuration μ.

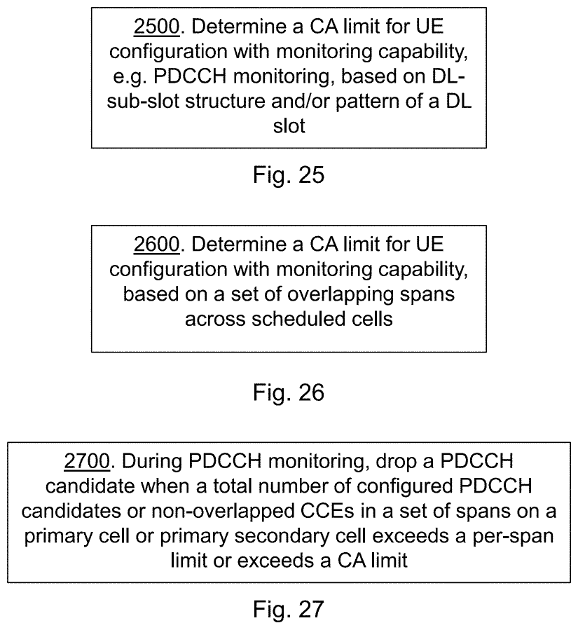

Thus, in one embodiment illustrated in the flowchart of FIG. 25, an operation by a network node includes determining 2500 a CA limit for UE configuration with monitoring capability, based on a DL-sub-slot structure and/or pattern of a DL slot. Thus, for example, the network node determines a CA limit for UE configuration based on a DL-sub-slot structure and/or pattern of a DL slot, and uses the UE configuration to control the UE's PDCCH monitoring. The CA limit may be determined for UE configuration for PDCCH monitoring. The CA limit may be determined for UE configuration for Rel-16 PDCCH monitoring.

In some embodiments, the network node includes a radio network node or another network node of a communications system. The network node may be a computing resource in a cloud computing environment.

In a further embodiment, the UE configuration includes at least one of: SCS for PDCCH monitoring; combination of minimum time (X) separation between the start of two PDCCH monitoring spans and maximum length (Y) of the spans; and number of component carriers (CC) configured for PDCCH monitoring.

Section 1.1 titled “DL-sub-slot pattern/structure determined from a rule” is described below.

In one non-limiting embodiment, a DL-sub-slot structure/pattern is determined for each combination (X,Y) and SCS configuration μ based on PDCCH monitoring span patterns of the N_{cells,r16}^{DL,(X,Y),μ} DL cells/component carriers associated with the combination (X,Y).

A corresponding further embodiment of the operation by the network node can include determining the DL-sub-slot structure and/or pattern is determined for each combination (X,Y) and SCS configuration μ based on PDCCH monitoring span patterns of N_{cells,r16}^{DL,(X,Y),μ} DL cells and/or component carriers associated with the combination (X,Y). The “X” can be the minimum separation between the start of two PDCCH monitoring spans.

In one non-limiting embodiment, in order to determine a DL-sub-slot pattern for combination (X,Y), first a bitmap b(l), 0<=l<=13 is generated, where b(l)=1 if symbol l of a slot is the starting symbol of a monitoring span of the relevant component carriers, b(l)=0 otherwise. The first DL-sub-slot in the DL-sub-slot pattern begins at the smallest 1 for which b(l)=1, and have duration T symbols. The next DL-sub-slot in the DL-sub-slot pattern begins at the smallest 1 not included in the previous DL-sub-slot(s) for which b(l)=1. In a preferred embodiment, the DL-sub-slot duration T is equal to X symbols, except possibly the last DL-sub-slot in a slot which can be of shorter duration than X. DL-sub-slot do not overlap. Every DL-sub-slot is contained in a single slot. The same DL-sub-slot pattern repeats in every slot, since the same monitoring span pattern of a given CC repeats in every slot.

A corresponding further embodiment of the operation by the network node to determine the DL-sub-slot pattern for the combination (X,Y), includes generating a bitmap b(l), 0<=l<=13, where b(l)=1 if symbol l of a slot is the starting symbol of a monitoring span of the relevant component carriers, b(l)=0 otherwise. In a further embodiment, the first DL sub-slot in the DL-sub-slot pattern begins at the smallest 1 for which b(l)=1, and has duration T symbols, and the next DL-sub-slot in the DL-sub-slot pattern begins at the smallest 1 not included in the previous DL-sub-slot(s) for which b(l)=1.

With the above embodiment, the DL-sub-slot pattern is not always fixed for a combination (X,Y) and SCS configuration μ. Rather, it varies with the actual monitoring span layout of the relevant component carriers.

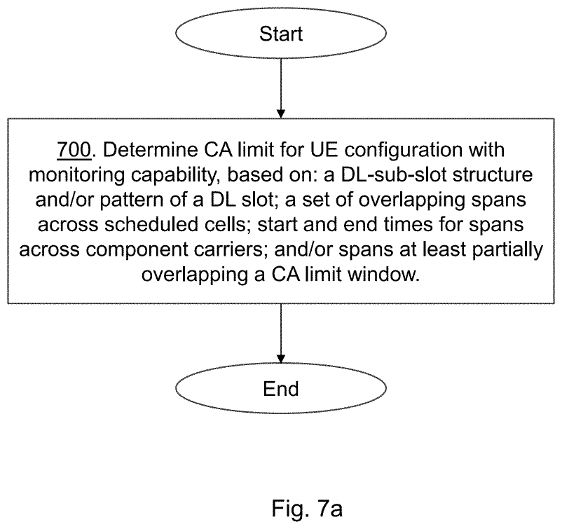

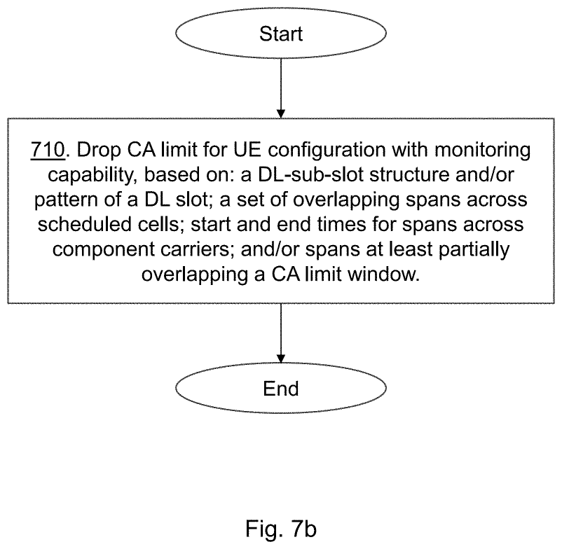

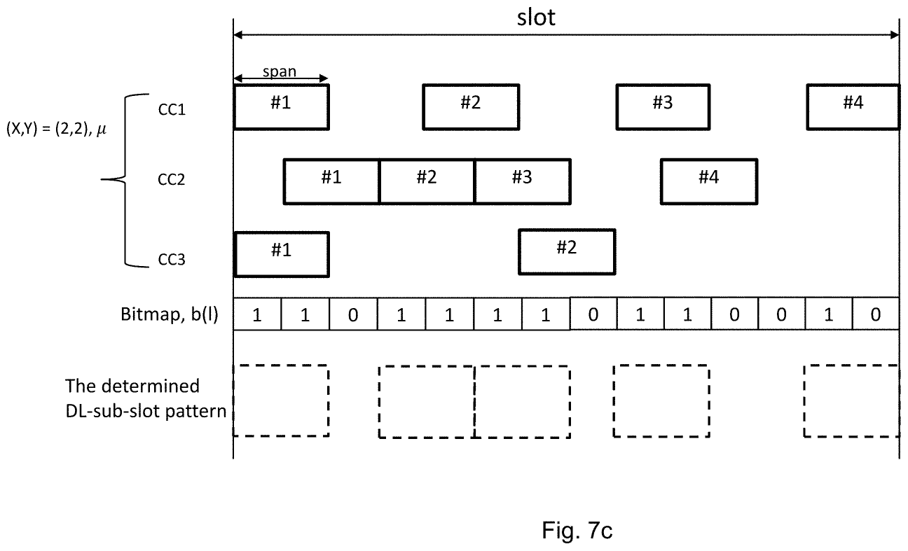

The method actions performed by the network node, such as a gNB, in a wireless communications network 1 according to embodiments herein will now be described with reference to a flowchart depicted in FIG. 7a.

Action 700. The network node determines a CA limit for UE configuration with monitoring capability, based on: a DL-sub-slot structure and/or pattern of a DL slot; a set of overlapping spans across scheduling cells; start and end times for spans across component carriers; and/or spans at least partially overlapping a CA limit window. The CA limit may be determined for UE configuration for physical downlink control channel, PDCCH, monitoring.

The UE configuration may comprise at least one of: SCS for PDCCH monitoring; a combination of minimum time (X) separation between the start of two PDCCH monitoring spans and maximum length (Y) of the spans; and number of component carriers configured for PDCCH monitoring. The DL-sub-slot structure and/or the pattern may be determined for each combination (X,Y) and SCS configuration μ based on PDCCH monitoring span patterns of N_{cells,r16}^{DL,(X,Y),μ} downlink, DL, cells and/or component carriers associated with the combination (X,Y). The determination of the DL-sub-slot pattern for the combination (X,Y), may comprise generating a bitmap b(l), wherein 0<=l<=13, an where b(l)=1 if symbol l of a slot is the starting symbol of a monitoring span of the relevant component carriers, and b(l)=0 otherwise. A first DL sub-slot in the DL-sub-slot pattern may begin at the smallest 1 for which b(l)=1, and has duration T symbols, and the next DL-sub-slot in the DL-sub-slot pattern may begin at the smallest 1 not included in the previous DL-sub-slot(s) for which b(l)=1.

The DL-sub-slot structure and/or pattern may be fixed for a given combination of the combination and μ {(X,Y), μ}, and does not vary with the actual monitoring span pattern of the component carriers, wherein “μ” is the SCS configuration. One DL-sub-slot structure and/or pattern may defined for each combination (X,Y) corresponding to a UE reported capability for Rel-16 PDCCH monitoring regardless of the numerology μ, wherein “μ” is the SCS configuration. A same DL-sub-slot structure and/or pattern may be defined for each combination (X,Y) of a given numerology μ, wherein “μ” is the SCS configuration. One or more DL-sub-slot structures and/or patterns are defined for each combination (X,Y) and DL numerology μ, corresponding to a UE reported capability for Rel-16 PDCCH monitoring, wherein “X” is the minimum separation between the start of two PDCCH monitoring spans, and wherein “μ” is the subcarrier spacing, SCS, configuration.

When the UE is configured with multiple DL cells using Rel-16 PDCCH monitoring capability associated with combination (X,Y), the same DL-sub-slot structure and/or pattern corresponding to combination (X,Y) may be applied to all the scheduling cells associated with the combination (X,Y).

When the UE is configured with a number of DL cells for all SCS Σ_{μ=0}¹ N_{cells,r16}^{DL,μ} smaller than or equal to a UE reported capability N_{cells}^{cap-r16} the method may not require the UE to monitor more than M_{PDCCH}^{max,(X,Y),μ}, PDCCH candidates per span or C_{PDCCH}^{max,(X,Y),μ} non-overlapped CCEs per span on the active DL one or more BWPs of one or more scheduling cells from the N_{cells,r16}^{DL,(X,Y),μ} downlink cells.

When the UE is configured with a number of DL cells for all SCS, Σ_{μ=0}¹N_{cells,r16}^{DL,μ} larger than a UE reported capability N_{cells}^{cap-r16}, the method may not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y)μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}·/Σⱼ₌₀¹(N_{cells,r16}^{DL,j}) [symbol] non-overlapped CCEs for any set of spans present in the same DL-sub-slot across the active DL BWP(s) of scheduling cell(s) from N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein the span is present in a DL-sub-slot if at least one symbol of the span is in the DL-sub-slot or overlaps with the DL-sub-slot.

When the UE is configured with a number of DL cells for all SCS, Σ_{μ=0}¹N_{cells,r16}^{DL,μ} larger than a UE reported capability N_{cells}^{cap-r16}, the method may not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans starting in the same DL-sub-slot across the active DL at least one BWP of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein the span is starting in a DL-sub-slot if the first symbol of the span is in the DL-sub-slot.

When the UE is configured with a number of DL cells for all SCS, Σ_{μ=0}¹ N_{cells,r16}^{DL,μ} larger than a UE reported capability N_{cells}^{cap-r16}, the method may not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non- overlapped CCEs for any set of spans present in the same DL-sub-slot across the active DL at least one BWPs of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with subcarrier spacing, SCS, configuration j, and wherein a span is present in a DL-sub-slot if at least one symbol of the span is in the DL-sub-slot or overlaps with the DL-sub-slot.

When the UE is configured with a number of DL cells for all SCS, μ_{μ=0}¹N_{cells,r16}^{DL,μ} larger than a UE reported capability N_{cells}^{cap-r16}, the method may not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non- overlapped CCEs for any set of spans starting in the same DL-sub-slot across the active DL at least one BWPs of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein a span is starting in a DL-sub-slot if the first symbol of the span is in the DL-sub-slot.

When the UE is configured with a number of DL cells for all subcarrier spacing, SCS, Σ_{μ=0}¹ N_{cells,r16}^{DL,μ} larger than a UE reported capability N_{cells}^{cap-r16}, the method may not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped control channel elements, CCEs, for any set of spans ending in the same DL-sub-slot across the active DL at least one BWP of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with subcarrier spacing, SCS, configuration j, and wherein a span is ending in a DL-sub-slot if at least the last symbol of the span is in the DL-sub-slot.

For each scheduled cell, the method may not require the UE to monitor on the active DL BWP with SCS configuration μ of the scheduling cell from the N_{cells,r16}^{DL,(X,Y),μ} downlink cells more than min(M_{PDCCH}^{max,(X,Y),μ}, M_{PDCCH}^{total,(X,Y),μ}) PDCCH candidates or more than min(C_{PDCCH}^{max,(X,Y),μ}, C_{PDCCH}^{total,(X,Y),μ}) non-overlapped CCEs per span.

The CA limit may be determined based on adjacent DL-sub-slot structures and/or patterns of adjacent DL slots. The CA limit may for example be determined based on the adjacent DL-sub-slot structures and/or patterns of adjacent DL slots located at the slot boundary.

The CA limit window may be based on a start of a slot. The CA limit window may be determined for each SCS based on all component carriers. The CA limit for a group of CCs, for each of a plurality of combinations (X,Y) is determined (3100) based on a minimum of span-limits among the combinations (X,Y). The CA limit window may extend across a slot boundary. It should be noted that the CA limit may be determined based on a start of a slot, and the CA limit may be applied for any set of spans at least partially overlapping in the CA limit window across an active DL, at least one BWP, of at least one scheduling cell from a downlink cells with at most one span per scheduling cell for each set.

The CA limit may be determined based on the set of overlapping spans across the scheduling cells and the set of overlapping spans across the scheduling cells is determined as a set which contains a span and all other spans which overlap with the span, with at most one span per scheduling cell. Additionally or alternatively, the set of overlapping spans may be determined as a set with the largest number of spans and with at most one span per scheduling cell, where any span in the set is at least overlapped with one or more other spans in the set.

This may be used when scheduling resources for one or more UEs in a CA scenario.

The method actions performed by the UE in a wireless communications network according to embodiments herein will now be described with reference to a flowchart depicted in FIG. 7b.

Action 710. The UE, during PDCCH monitoring, drops a PDCCH candidate when a total number of configured PDCCH candidates or non-overlapped CCEs, in a set of spans on a primary cell or primary secondary cell exceeds a per-span limit or exceeds a CA limit.

FIG. 7c illustrates an example of DL-sub-slot pattern determination according to the above embodiment. In FIG. 7c, DL-sub-slot pattern determination is based on monitoring span patterns of the 3 DL cells/component carriers associated with the combination (X,Y)=(2,2). There are 5 DL-sub-slots in a slot where each DL-sub-slot has duration of 2 symbols (=X). Each span is present in/overlap in time with at least one DL-sub-slot in the DL-sub-slot pattern.

For UE configured with multiple DL cells using Rel-16 PDCCH monitoring capability associated with combination (X,Y) and SCS configuration μ, the same DL-sub-slot pattern corresponding to combination (X,Y) is applied to all the scheduling cells associated with the combination (X,Y).

Section 1.2 titled “DL-sub-slot pattern/structure defined in the specification” is described below.

In one non-limiting embodiment, one or more DL-sub-slot structures/patterns are defined in the specification for the purpose of determining Rel-16 PDCCH monitoring capability (CA-limit) for the carrier aggregation case. In this case, the DL-sub-slot pattern is fixed for a given combination of {(X,Y), μ}, and does not vary with the actual monitoring span pattern of the component carriers under consideration.

In one non-limiting embodiment, one DL-sub-slot structure/pattern is defined for each combination (X,Y) corresponding to the UE reported capability for Rel-16 PDCCH monitoring regardless of the numerology μ. Alternatively, a same DL-sub-slot structure/pattern is defined for each combination (X,Y) of a given numerology μ, but the DL-sub-slot structure/pattern may vary among different numerology μ.

A corresponding further embodiment of the operation by the network node includes that the DL-sub-slot structure and/or pattern is fixed for a given combination of {(X,Y), μ}, and does not vary with the actual monitoring span pattern of the component carriers. The “X” can be the minimum separation between the start of two PDCCH monitoring spans. The “μ” can be the SCS configuration.

In another corresponding further embodiment of the operation by the network node includes that a same DL-sub-slot structure and/or pattern is defined for each combination (X,Y) of a given numerology μ. The “X” can be the minimum separation between the start of two PDCCH monitoring spans. The “μ” can be the subcarrier spacing, SCS, configuration.

In another embodiment, one or more DL-sub-slot structures/patterns are defined for each combination (X,Y) and DL numerology μ, corresponding to the UE reported capability for Rel-16 PDCCH monitoring. A UE can be configured with one DL-sub-slot structure/pattern for each combination (X,Y) and DL numerology μ, which the UE is capable of supporting.

In another embodiment, one or more DL-sub-slot structures/patterns are defined for each combination (X,Y) and DL numerology μ, corresponding to the UE reported capability for Rel-16 PDCCH monitoring. A UE can report its capability for the DL-sub-slot structure/pattern, one for each combination (X,Y) and DL numerology μ, which the UE is capable of supporting.

A corresponding further embodiment of the operation by the network node includes that one or more DL-sub-slot structures and/or patterns are defined for each combination (X,Y) and DL numerology μ, corresponding to a UE reported capability for Rel-16 PDCCH monitoring. The “X” can be the minimum separation between the start of two PDCCH monitoring spans.

For UE configured with multiple DL cells using Rel-16 PDCCH monitoring capability associated with combination (X,Y), the same DL-sub-slot structure/pattern corresponding to combination (X,Y) is applied to all the scheduling cells associated with the combination (X,Y).

A corresponding further embodiment of the operation by the network node includes that, when the UE is configured with multiple DL cells using Rel-16 PDCCH monitoring capability associated with combination (X,Y), the same DL-sub-slot structure and/or pattern corresponding to combination (X,Y) is applied to all the scheduling cells associated with the combination (X,Y). The “X” can be the minimum separation between the start of two PDCCH monitoring spans.

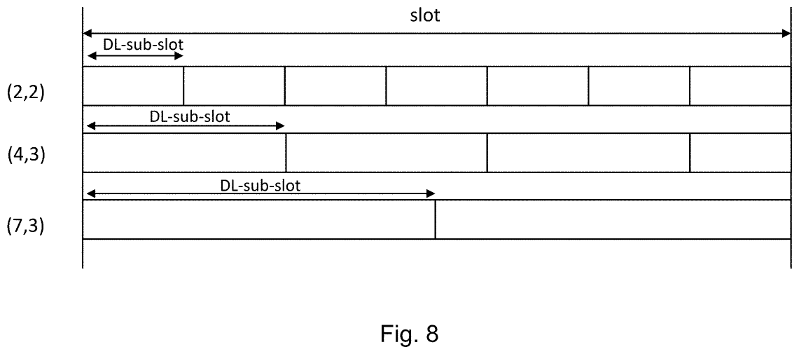

FIG. 8 illustrates one example of DL-sub-slot structures/patterns for different combinations (X,Y) for the purpose of determining Rel-16 CA limit. Here for (X,Y)=(2,2), the DL-sub-slot structure/pattern corresponds to 7 DL-sub-slots of length 2 symbols each, while for (X,Y)=(7,3), the DL-sub-slot structure/pattern corresponds to 2 DL-sub-slots of length 7 symbols each. For (X,Y)=(4,3), the DL-sub-slot structure/pattern may corresponds to 4 DL-sub-slots, 3 of which have length 4 symbols and one with 2 symbols. Other combinations of DL-sub-slots forming the DL-sub-slot structure/pattern for each (X,Y) are possible.

Section 2.0 titled “Principle of Rel-16 CA limit determination based on the DL-sub-slot pattern/structure” is described below.

In this section, the solutions for determining Rel-16 CA limit and the principle of how the CA limit is applied are provided.

The discussion is given for the case where all DL cells are with Rel-16 PDCCH monitoring capability. In the case of UE supporting multiple DL cells with a mixture of Rel-15 and Rel-16 capabilities, the CA limits can be determined separately for DL cells with Rel-15 capability using the existing procedure and for DL cells with Rel-16 capability using the principle described in this section.

Let a UE be configured with N_{cells,r16}^{DL,μ} downlink cells using Rel-16 PDCCH monitoring capability, and with N_{cells,r16}^{DL,(X,Y),μ} of the N_{cells,r16}^{DL,μ} downlink cells using combination (X,Y) for PDCCH monitoring, and having active DL BWP(s) using SCS configuration μ.

Section 2.1 titled “Number of configured cells is not larger than UE capability in number of monitoring cells (i.e., no CA limit needed)” is described below.

In one non-limiting embodiment, if a UE is configured with the number of DL cells for all SCS, Σ_{μ=0}¹N_{cells,r16}^{DL,μ} smaller than or equal to the UE reported capability N_{cells}^{cap-r16}, the UE is not required to monitor more than M_{PDCCH}^{max,(X,Y),μ} PDCCH candidates per span or C_{PDCCH}^{max,(X,Y),μ} non-overlapped CCEs per span on the active DL BWP(s) of the scheduling cell(s) from the N_{cells,r16}^{DL,(X,Y),μ} downlink cells.

A corresponding further embodiment of the operation by the network node, when the UE is configured with a number of DL cells for all subcarrier spacing, SCS, Σ_{μ=0}¹N_{cells,r16}^{DL,μ} smaller than or equal to a UE reported capability N_{cells}^{cap-r16}, the operation does not require the UE to monitor more than M_{PDCCH}^{max,(X,Y),μ} PDCCH candidates per span or C_{PDCCH}^{max,(X,Y),μ} non-overlapped control channel elements, CCEs, per span on the active DL at least one BandWidth Part, BWP of at least one scheduling cell from the N_{cells,r16}^{DL,(X,Y),μ} downlink cells.

Section 2.2 titled “Number of configured cells is larger than UE capability in number of monitoring cells (i.e., CA limit is used)” is described below.

Section 2.2.1 titled “DL-sub-slot pattern determined from the span patterns as in Section 1.1” is initially described below.

Two solutions are described in the following embodiments.

In one non-limiting embodiment, if a UE is configured with the number of DL cells for all SCS, Σ_{μ=0}¹ N_{cells,r16}^{DL,μ} larger than the UE reported capability N_{cells}^{cap-r16}, the UE is not required to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans present in the same DL-sub-slot across the active DL BWP(s) of scheduling cell(s) from the N_{cells,r16}^{DL,(X,Y),μ} downlink cells with at most one span per scheduling cell for each set, where N_{cells,r16}^{DL,j} is a number of configured cells using Rel-16 PDCCH monitoring capability with SCS configuration j. A span is said to be present in a DL-sub-slot if at least one symbol of the span is in the DL-sub-slot or overlaps with the DL-sub-slot.

A corresponding further embodiment of the operation by the network node, when the UE is configured with a number of DL cells for all SCS, Σ_{μ=0}¹ N_{cells,r16}^{DL,μ} larger than a UE reported capability N_{cells}^{cap-r16}, the operation does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans present in the same DL-sub-slot across the active DL BWP(s) of scheduling cell(s) from N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein a span is present in a DL-sub-slot if at least one symbol of the span is in the DL-sub-slot or overlaps with the DL-sub-slot.

To further clarify the above embodiment, let Mₛ be the number of PDCCH candidates in span s and Cₛ be the number of non-overlapped CCEs in span s. If Σ_{s∈R}Mₛ≤M_{PDCCH}^{total,(X,Y),μ} and Σ_{s∈R}CₛδC_{PDCCH}^{total,(X,Y),μ} for all sets R, the UE is required to monitor all PDCCH candidates. If Σ_{s∈R} Mₛ>M_{PDCCH}^{total,(X,Y),μ} or Σ_{s∈R} Cₛ>C_{PDCCH}^{total,(X,Y),μ}, for some set R, then the UE should drop PDCCH candidates from different spans in R in a predetermined manner. If after dropping candidates, the Σ_{s∈R} Mₛ≤M_{PDCCH}^{total,(X,Y),μ} and Σ_{s∈R} Cₛ≤C_{PDCCH}^{total,(X,Y),μ} for the set R, then the UE monitors the candidates which are not dropped. One example of a predetermined manner is that the UE drops candidates only from spans in the primary cell. In the embodiment above, set R is a set of spans s which are present in the same DL-sub-slot across the active DL BWP(s) of scheduling cell(s) from the N_{cells,r16}^{DL,(X,Y),μ} downlink cells, with at most one span s per scheduling cell.

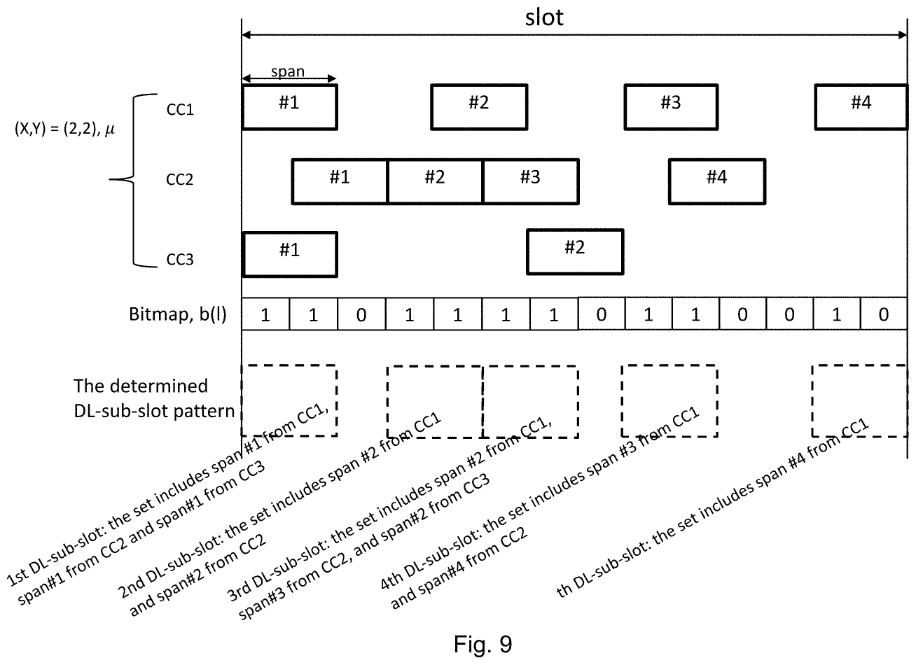

FIG. 9 illustrates an example of the sets of spans determined according to the above embodiment. More particularly, FIG. 9 illustrates example sets of spans present in the same DL-sub-slot across the active DL BWP(s) of scheduling cell(s) with at most one span per scheduling cell for each set. For example, for the set of spans present in the 1st DL-sub-slot, the total limits, M_{PDCCH}^{total,(2,2),μ} is not to be exceeded by the number of monitored PDCCH candidates summed over span #1 in CC1, span #1 in CC2, and span #1 in CC3. For the set of spans present in the 3rd DL-sub-slot, the total limits, M_{PDCCH}^{total,(2,2),μ} is not to be exceeded by the number of monitored PDCCH candidates summed over span #2 in CC1, span #3 in CC2, and span #2 in CC3.

In one non-limiting embodiment, if a UE is configured with the number of DL cells for all SCS, Σ_{μ=0}¹ N_{cells,r16}^{DL,μ} larger than the UE reported capability N_{cells}^{cap-r16}, the UE is not required to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans starting in the same DL-sub-slot across the active DL BWP(s) of scheduling cell(s) from the N_{cells,r16}^{DL,(X,Y),μ} downlink cells with at most one span per scheduling cell for each set, where N_{cells,r16}^{DL,j} is a number of configured cells using Rel-16 PDCCH monitoring capability with SCS configuration j. A span is said to be starting in a DL-sub-slot if the first symbol of the span is in the DL-sub-slot.

A corresponding further embodiment of the operation by the network node, when the UE is configured with a number of DL cells for all SCS, Σ_{μ=0}¹ N_{cells,r16}^{DL,μ} is larger than a UE reported capability N_{cells}^{cap-r16}, the operation does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans starting in the same DL-sub-slot across the active DL BWP(s) of scheduling cell(s) from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein the span is starting in a DL-sub-slot if the first symbol of the span is in the DL-sub-slot.

To further clarify the above embodiment, let Mₛ be the number of PDCCH candidates in span s and Cₛ be the number of non-overlapped CCEs in span s. If Σ_{s∈R} Mₛ≤M_{PDCCH}^{total,(X,Y),μ} and Σ_{s∈R} Cₛ≤C_{PDCCH}^{total,(X,Y),μ} for all sets R, the UE is required to monitor all PDCCH candidates. If Σ_{s∈R} Mₛ>M_{PDCCH}^{total,(X,Y),μ} or Σ_{s∈R} Cₛ>C_{PDCCH}^{total,(X,Y),μ}, for some set R, then the UE should drop PDCCH candidates from different spans in R in a predetermined manner. If after dropping candidates, the Σ_{s∈R} Mₛ<M_{PDCCH}^{total,(X,Y),μ} and Σ_{s∈R} Cₛ≤C_{PDCCH}^{total,(X,Y),μ} for the set R, then the UE monitors the candidates which are not dropped. One example of a predetermined manner is that the UE drops candidates only from spans in the primary cell. In the embodiment above, set R is a set of spans s which start in the same DL-sub-slot across the active DL BWP(s) of scheduling cell(s) from the N_{cells,r16}^{DL,(X,Y),μ} downlink cells, with at most one span s per scheduling cell.

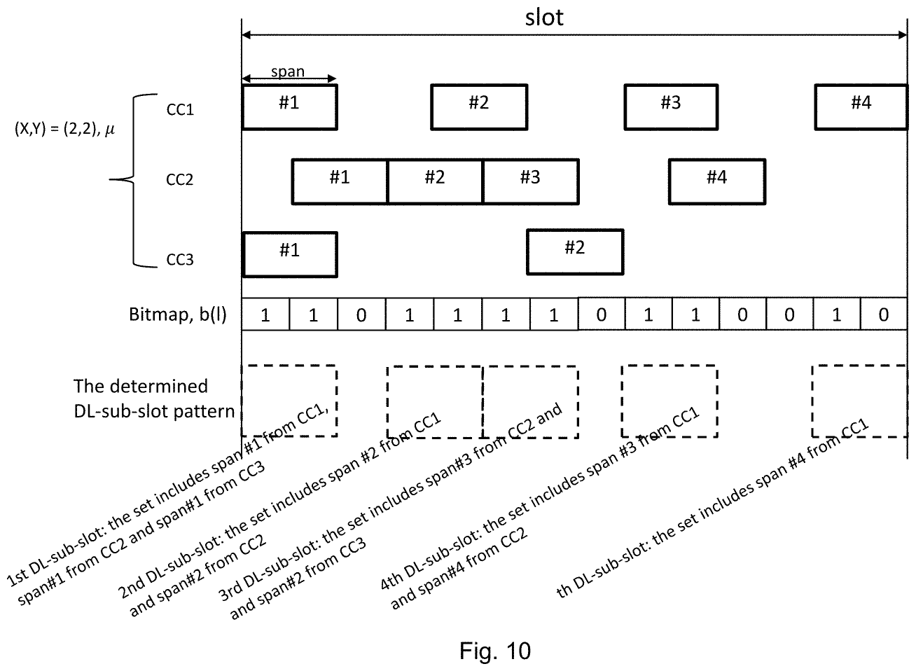

FIG. 10 illustrates an example of the sets of spans determined according to the above embodiment. More particularly, FIG. 10 illustrates example sets of spans present in the same DL-sub-slot across the active DL BWP(s) of scheduling cell(s) with at most one span per scheduling cell for each set. For example, for the set of spans present in the 1st DL-sub-slot, the total limits, M_{PDCCH}^{total,(2,2),μ} is not to be exceeded by the number of monitored PDCCH candidates summed over span #1 in CC1, span #1 in CC2, and span #1 in CC3. For the set of spans present in the 3rd DL-sub-slot, the total limits, M_{PDCCH}^{total,(2,2),μ} is not to be exceeded by the number of monitored PDCCH candidates summed over span #3 in CC2 and span #2 in CC3, while span #2 in CC1 is not included since it does not start within the 3rd DL-sub-slot.

Section 2.2.2 titled “DL-sub-slot pattern determined from the span patterns as Section 1.2 is now described below.

Three solutions are described in the following embodiments.

In one non-limiting embodiment, if a UE is configured with the number of DL cells for all SCS, Σ_{μ=0}¹ N_{cells,r16}^{DL,μ} larger than the UE reported capability N_{cells}^{cap-r16}, the UE is not required to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans present in the same DL-sub-slot across the active DL BWP(s) of scheduling cell(s) from the N_{cells,r16}^{DL,(X,Y),μ} downlink cells with at most one span per scheduling cell for each set, where N_{cells,r16}^{DL,j} is a number of configured cells using Rel-16 PDCCH monitoring capability with SCS configuration j. A span is said to be present in a DL-sub-slot if at least one symbol of the span is in the DL-sub-slot or overlaps with the DL-sub-slot.

A corresponding further embodiment of the operation by the network node, when the UE is configured with a number of DL cells for all SCS, Σ_{μ=0}¹ N_{cells,r16}^{DL,μ} larger than a UE reported capability N_{cells}^{cap-r16}, the operation does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans present in the same DL-sub-slot across the active DL at least one BandWidth Part, BWP, of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein a span is present in a DL-sub-slot if at least one symbol of the span is in the DL-sub-slot or overlaps with the DL-sub-slot.

To further clarify the above embodiment, let M, be the number of PDCCH candidates in span s and Cₛ be the number of non-overlapped CCEs in span s. If Σ_{s∈R} Mₛ≤M_{PDCCH}^{total,(X,Y),μ} and Σ_{s∈R} Cₛ≤C_{PDCCH}^{total,(X,Y),μ} for all sets R, the UE is required to monitor all PDCCH candidates. If Σ_{s∈R} Mₛ>M_{PDCCH}^{total,(X,Y),μ} or Σ_{s∈R} Cₛ>C_{PDCCH}^{total,(X,Y),μ}, for some set R, then the UE should drop PDCCH candidates from different spans in R in a predetermined manner. If after dropping candidates, the Σ_{s∈R} Mₛ≤M_{PDCCH}^{total,(X,Y),μ} and Σ_{s∈R} Cₛ≤C_{PDCCH}^{total,(X,Y),μ} the set R, then the UE monitors the candidates which are not dropped. One example of a predetermined manner is that the UE drops candidates only from spans in the primary cell. In the embodiment above, set R is a set of spans s which are present in the same DL-sub-slot across the active DL BWP(s) of scheduling cell(s) from the N_{cells,r16}^{DL,(X,Y),μ} downlink cells, with at most one span s per scheduling cell.

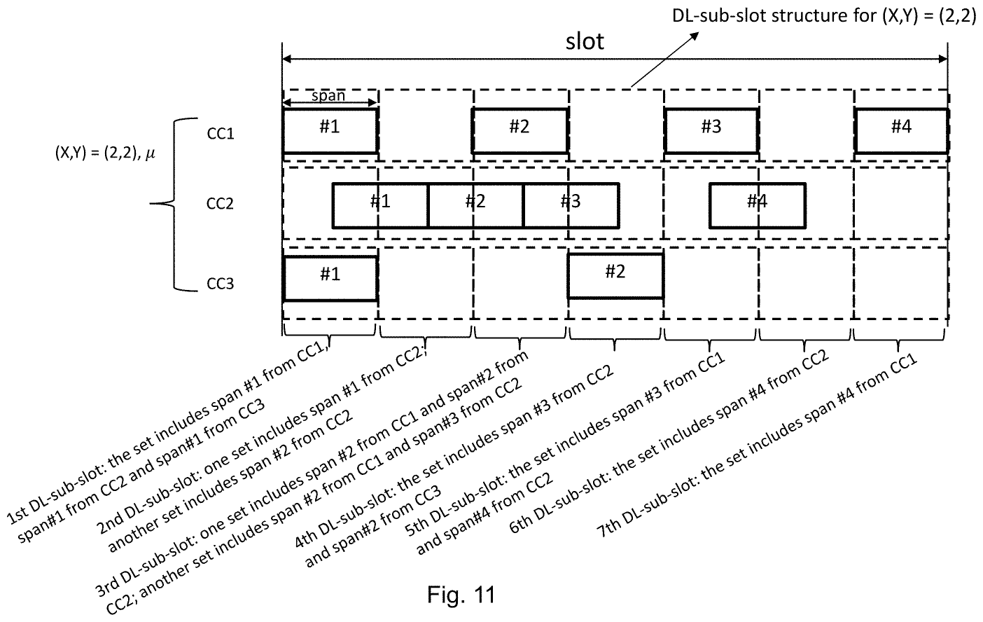

FIG. 11 illustrates an example of the sets of spans determined according to the above embodiment. More particularly, FIG. 11 shows example sets of spans present in the same DL-sub-slot across the active DL BWP(s) of scheduling cell(s) with at most one span per scheduling cell for each set. For example, for the set of spans present in the 1st DL-sub-slot, the total limits, M_{PDCCH}^{total,(2,2),μ} is not to be exceeded by the number of monitored PDCCH candidates summed over span #1 in CC1, span #1 in CC2, and span #1 in CC3. For the set of spans present in the 3rd DL-sub-slot, the total limits, M_{PDCCH}^{total,(2,2),μ} is not to be P PDCCH exceeded by the number of monitored PDCCH candidates for both 1) set of span #2 in CC1 and span #2 in CC2, and 2) span #2 in CC1 and span #3 in CC2.

In one non-limiting embodiment, if a UE is configured with the number of DL cells for all SCS, Σ_{μ=0}¹ N_{cells,r16}^{DL,μ} larger than the UE reported capability N_{cells}^{cap-r16}, the UE is not required to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans starting in the same DL-sub-slot across the active DL BWP(s) of scheduling cell(s) from the N_{cells,r16}^{DL,(X,Y),μ} downlink cells with at most one span per scheduling cell for each set, where N_{cells,r16}^{DL,j} is a number of configured cells using Rel-16 PDCCH monitoring capability with SCS configuration j. A span is said to be starting in a DL-sub-slot if the first symbol of the span is in the DL-sub-slot.

A corresponding further embodiment of the operation by the network node, when the UE is configured with a number of DL cells for all SCS, Σ_{μ=0}¹ N_{cells,r16}^{DL,μ} larger than a UE reported capability N_{cells}^{cap-r16}, the operation does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans starting in the same DL-sub-slot across the active DL at least one BandWidth Part, BWP, of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein a span is starting in a DL-sub-slot if the first symbol of the span is in the DL-sub-slot.

To further clarify the above embodiment, let M, be the number of PDCCH candidates in span s and Cₛ be the number of non-overlapped CCEs in span s. If Σ_{s∈R} Mₛ≤M_{PDCCH}^{total,(X,Y),μ} and Σ_{s∈R} R Cₛ≤C_{PDCCH}^{total,(X,Y),μ} for all sets R, the UE is required to monitor all PDCCH candidates. If Σ_{s∈R} Mₛ>M_{PDCCH}^{total,(X,Y),μ} or Σ_{s∈R} Cₛ>C_{PDCCH}^{total,(X,Y),μ}, for some set R, then the UE should drop PDCCH candidates from different spans in R in a predetermined manner. If after dropping candidates, the Σ_{s∈R} Mₛ≤M_{PDCCH}^{total,(X,Y),μ} and Σ_{s∈R} Cₛ≤C_{PDCCH}^{total,(X,Y),μ} for the set R, then the UE monitors the candidates which are not dropped. One example of a predetermined manner is that the UE drops candidates only from spans in the primary cell. In the embodiment above, set R is a set of spans s which start in the same DL-sub-slot across the active DL BWP(s) of scheduling cell(s) from the N_{cells,r16}^{DL,(X,Y),μ} downlink cells, with at most one span s per scheduling cell.

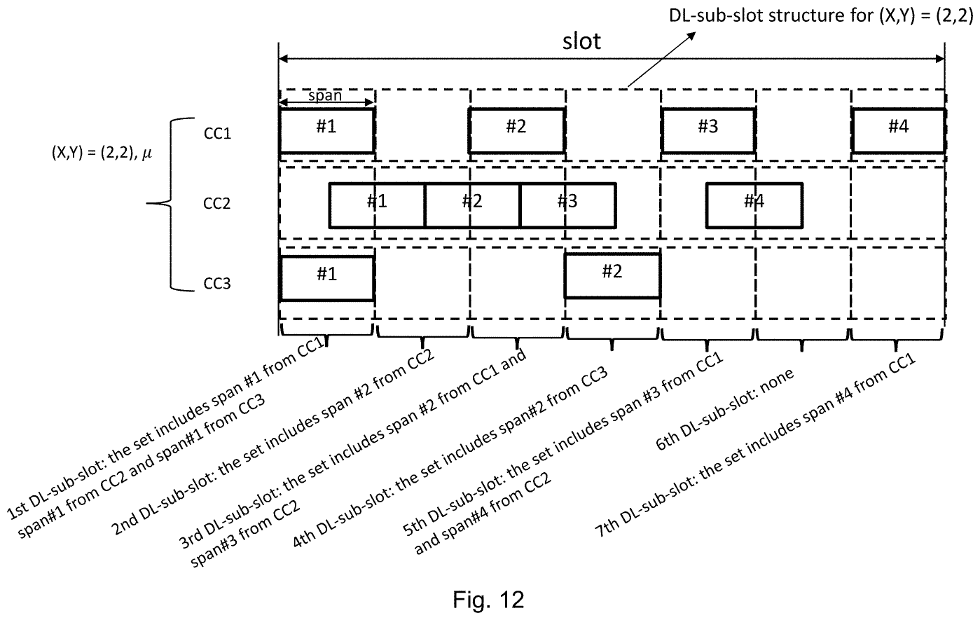

FIG. 12 illustrates an example of the sets of spans determined according to the above embodiment. More particularly, FIG. 12 shows example sets of spans starting in the same DL-sub-slot across the active DL BWP(s) of scheduling cell(s) with at most one span per scheduling cell for each set. For example, for the set of spans starting in the 1st DL-sub-slot, the total limits, M_{PDCCH}^{total,(2,2),μ} is not to be exceeded by the number of monitored PDCCH candidates summed over span #1 in CC1, span #1 in CC2, and span #1 in CC3. For the set of spans starting in the 3rd DL-sub-slot, the total limits, M_{PDCCH}^{total,(2,2),μ} is not to be exceeded by the number of monitored PDCCH candidates summed over span #2 in CC1 and span #3 in CC2.

In one non-limiting embodiment, if a UE is configured with the number of DL cells for all SCS, Σ_{μ=0}¹ N_{cells,r16}^{DL,μ} larger than the UE reported capability N_{cells}^{cap-r16}, the UE is not required to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans ending in the same DL-sub-slot across the active DL BWP(s) of scheduling cell(s) from the N_{cells,r16}^{DL,(X,Y),μ} downlink cells with at most one span per scheduling cell for each set, where N_{cells,r16}^{DL,j} is a number of configured cells using Rel-16 PDCCH monitoring capability with SCS configuration j. A span is said to be ending in a DL-sub-slot if at least the last symbol of the span is in the DL-sub-slot.

A corresponding further embodiment of the operation by the network node, when the UE is configured with a number of DL cells for all SCS, Σ_{μ=0}¹ N_{cells,r16}^{DL,μ} larger than a UE reported capability N_{cells}^{cap-r16}, the operation does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans ending in the same DL-sub-slot across the active DL at least one BandWidth Part, BWP, of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein a span is ending in a DL-sub-slot if at least the last symbol of the span is in the DL-sub-slot.

To further clarify the above embodiment, let Mₛ be the number of PDCCH candidates in span s and Cₛ be the number of non-overlapped CCEs in span s. If Σ_{s∈R} Mₛ≤M_{PDCCH}^{total,(X,Y),μ} and Σ_{s∈R} Cₛ≤C_{PDCCH}^{total,(X,Y),μ} for all sets R, the UE is required to monitor all PDCCH candidates. If Σ_{s∈R} Mₛ>M_{PDCCH}^{total,(X,Y),μ} or Σ_{s∈R} Cₛ>C_{PDCCH}^{total,(X,Y),μ}, for some set R, then the UE should drop PDCCH candidates from different spans in R in a predetermined manner. If after dropping candidates, the Σ_{s∈R} Mₛ≤M_{PDCCH}^{total,(X,Y),μ} and Σ_{s∈R} Cₛ≤<C_{PDCCH}^{total,(X,Y),μ} for the set R, then the UE monitors the candidates which are not dropped. One example of a predetermined manner is that the UE drops candidates only from spans in the primary cell. In the embodiment above, set R is a set of spans s which end in the same DL-sub-slot across the active DL BWP(s) of scheduling cell(s) from the N_{cells,r16}^{DL,(X,Y),μ} downlink cells, with at most one span s per scheduling cell.

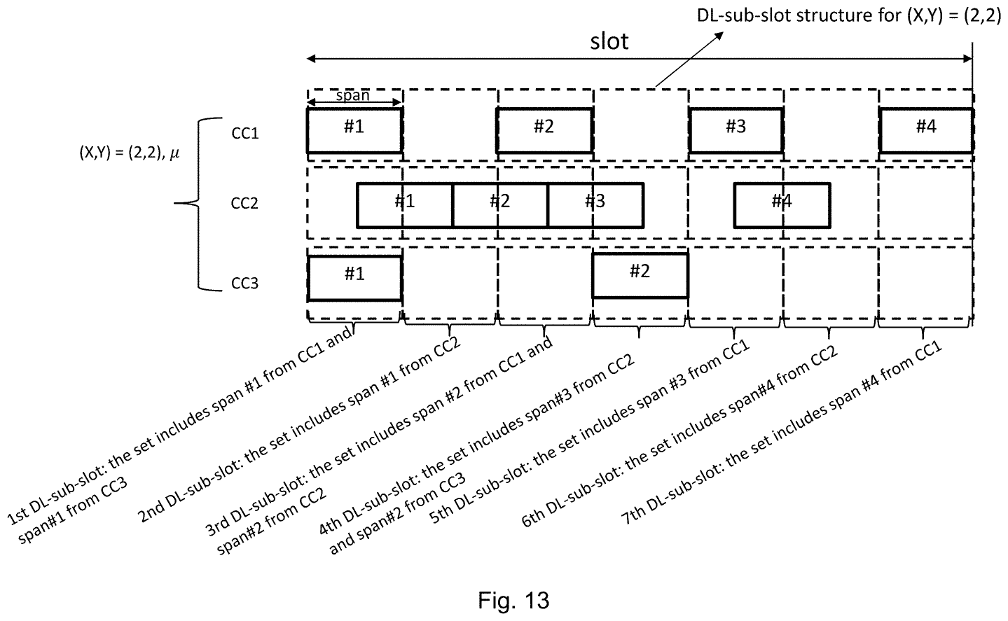

FIG. 13 illustrates an example of the sets of spans determined according to the above embodiment. More particularly, FIG. 13 shows example sets of spans ending in the same DL-sub-slot across the active DL BWP(s) of scheduling cell(s) with at most one span per scheduling cell for each set. For example, for the set of spans ending in the 1st DL-sub-slot, the total limits, M_{PDCCH}^{total,(2,2),μ} is not to be exceeded by the number of monitored PDCCH candidates summed over span #1 in CC1 and span #1 in CC3. For the set of spans ending in the 3rd DL-sub-slot, the total limits, M_{PDCCH}^{total,(2,2),μ} is not to be exceeded by the number of monitored PDCCH candidates summed over span #2 in CC1 and span #2 in CC2.

Section 2.3 titled “The per-span limit per-serving cell still needs to be respected” will now be described below.

In one non-limiting embodiment, for each scheduled cell, the UE is not required to monitor on the active DL BWP with SCS configuration μ of the scheduling cell from the N_{cells,r16}^{DL,(X,Y),μ} downlink cells more than min(M_{PDCCH}^{max,(X,Y),μ}, M_{PDCCH}^{total,(X,Y),μ}) PDCCH candidates or more than min(C_{PDCCH}^{max,(X,Y),μ}, C_{PDCCH}^{total,(X,Y),μ}) non-overlapped CCEs per span. That is, apart from the CA limit for a set of spans across scheduling cells, the limit per span for each scheduling cell still needs to be respected.

A corresponding further embodiment of the operation by the network node, includes for each scheduled cell, the operation does not require the UE to monitor on the active DL BWP with SCS configuration μ of the scheduling cell from the N_{cells,r16}^{DL,(X,Y),μ} downlink cells more than min(M_{PDCCH}^{max,(X,Y),μ}, M_{PDCCH}^{total,(X,Y),μ}) PDCCH candidates or more than min(C_{PDCCH}^{max,(X,Y),μ}, C_{PDCCH}^{total,(X,Y),μ}) non-overlapped CCEs per span.

Section 3 titled “principle of Rel-16 CA limit determination based on overlapping spans across scheduling cells” will now be described below.

In this section of the disclosure, the solutions for determining Rel-16 CA limit is not based on the DL-sub-slot pattern/structure, but instead is based on overlapping spans across scheduling cells.

Let a UE be configured with N_{cells,r16}^{DL,μ} downlink cells using Rel-16 PDCCH monitoring capability, and with N_{cells,r16}^{DL,(X,Y),μ} of the N_{cells,r16}^{DL,μ} downlink cells using combination (X,Y) for PDCCH monitoring, and having active DL BWP(s) using SCS configuration μ.

In one non-limiting embodiment, if a UE is configured with the number of DL cells for all SCS, Σ_{μ=0}¹ N_{cells,r16}^{DL,μ} larger than the UE reported capability N_{cells}^{cap-r16},

For spans which do not overlap in time domain with any other spans, the UE is not required to monitor more than M_{PDCCH}^{max,(X,Y),μ} PDCCH candidates or C_{PDCCH}^{max,(X,Y),μ} non-overlapped CCEs per span on the active DL BWP(s) of the scheduling cell(s) from the N_{cells,r16}^{DL,(X,Y),μ} downlink cells.

Among the remaining overlapped spans, the UE is not required to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] non-overlapping CCEs for any set of overlapped spans across the active DL BWP(s) of scheduling cell(s) from the N_{cells,r16}^{DL,(X,Y),μ} downlink cells with at most one span per scheduling cell for each set, where N_{cells,r16}^{DL,j} is a number of configured cells using Rel-16 PDCCH monitoring capability with SCS configuration j.

To further clarify the above embodiment, let Mₛ be the number of PDCCH candidates in span s and Cₛ be the number of non-overlapped CCEs in span s. If Σ_{s∈R} Mₛ≤M_{PDCCH}^{total,(X,Y),μ} and Σ_{s∈R} Cₛ≤C_{PDCCH}^{total,(X,Y),μ} for all sets R, the UE is required to monitor all PDCCH candidates. If Σ_{s∈R} Mₛ>M_{PDCCH}^{total,(X,Y),μ} or Σ_{s∈R} Cₛ>C_{PDCCH}^{total,(X,Y),μ}, for some set R, then the UE should drop PDCCH candidates from different spans in R in a predetermined manner. If after dropping candidates, the Σ_{s∈R} Mₛ≤M_{PDCCH}^{total,(X,Y),μ} and Σ_{s∈R} Cₛ≤C_{PDCCH}^{total,(X,Y),μ} for the set R, then the UE monitors the candidates which are not dropped. One example of a predetermined manner is that the UE drops candidates only from spans in the primary cell. In the embodiment above, set R is a set of spans s which overlap across the active DL BWP(s) of scheduling cell(s) from the N_{cells,r16}^{DL,(X,Y),μ} downlink cells with at most one span per scheduling cell for each set.

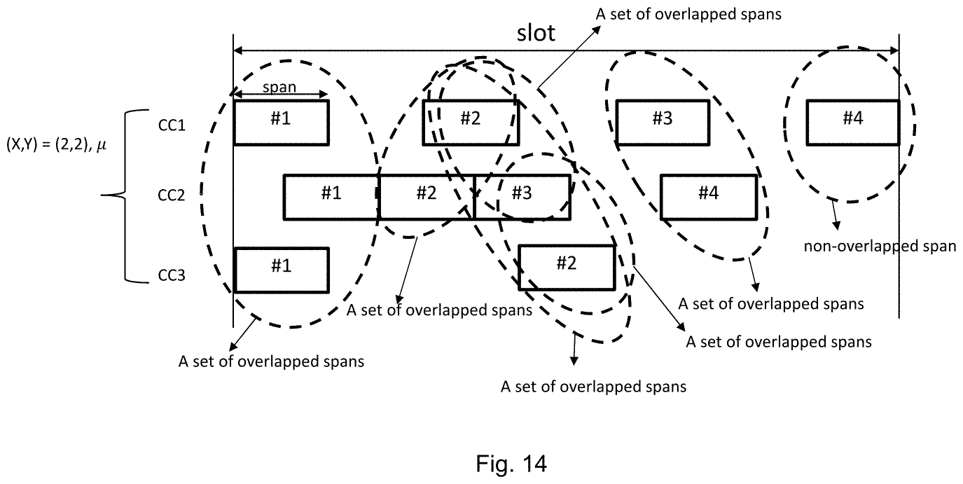

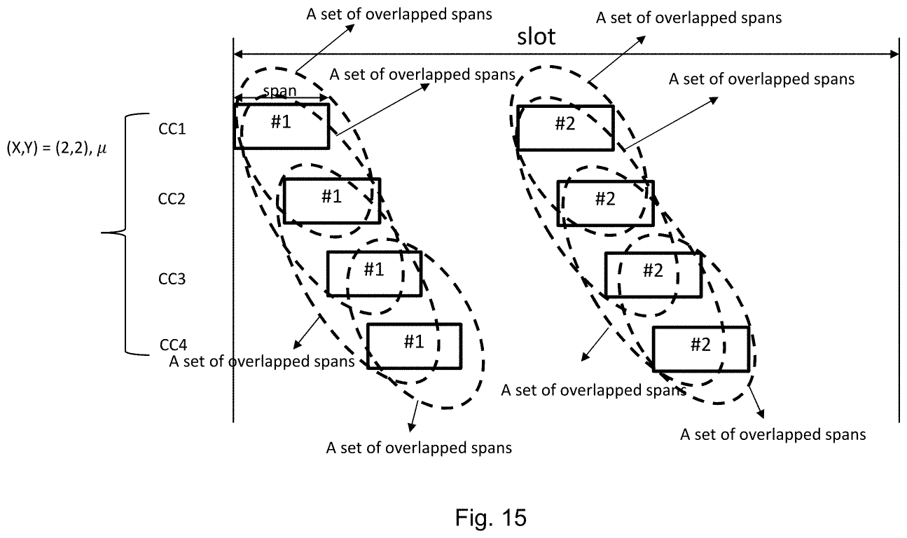

In one version of above embodiment, the set of overlapped spans across scheduling cells is the set which contains a span and all other spans which overlap with this span, with at most one span per scheduling cell. Two examples of the sets of overlapped spans across the active DL BWP(s) of scheduling cell(s) determined according to this embodiment are given in FIG. 14 and FIG. 15. FIG. 14 shows example sets of overlapped spans across DL cells, where the non-overlapped span is excluded from any set of overlapped spans. FIG. 15 shows example sets of overlapped spans.

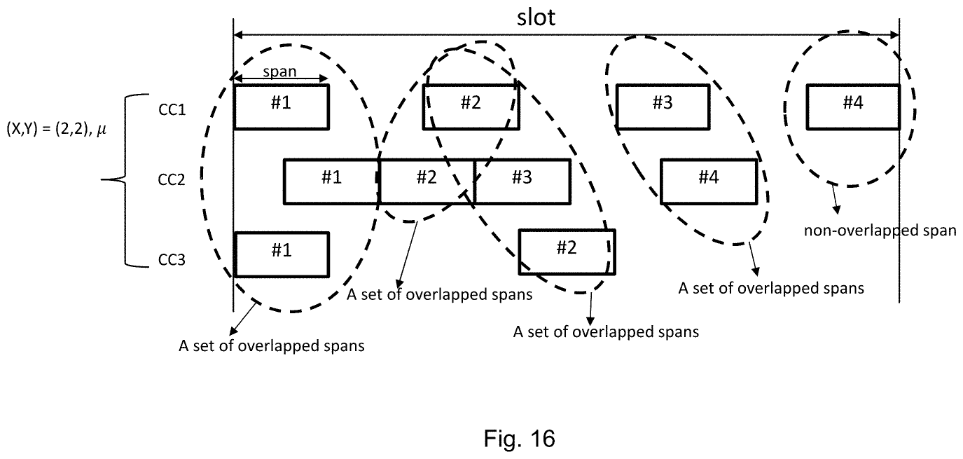

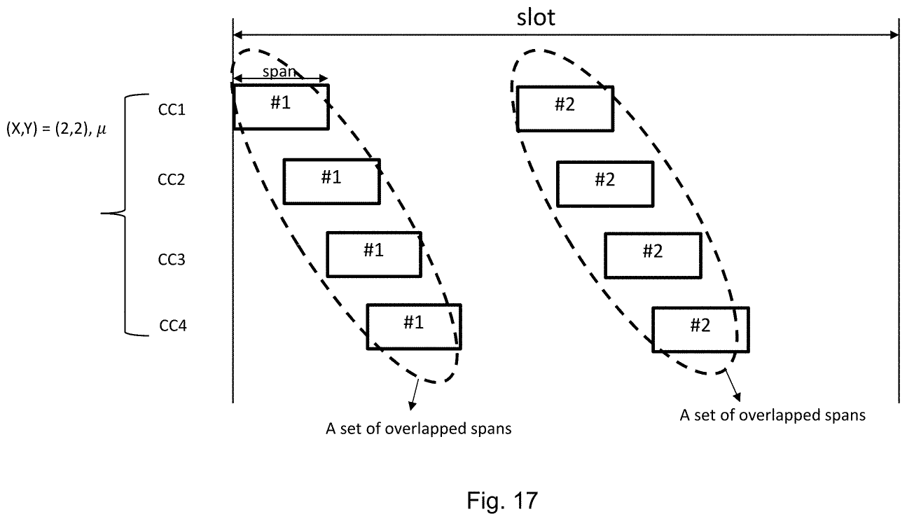

In another version of above embodiment, the set of overlapped spans across scheduling cells is the set with the largest number of spans and with at most one span per scheduling cell, where any span in the set is at least overlapped with one or more other spans in the set. Two examples of the sets of overlapped spans across the active DL BWP(s) of scheduling cell(s) determined according to this embodiment are given in FIG. 16 and FIG. 17. FIG. 16 shows example sets of overlapped spans across DL cells. The non-overlapped span is excluded from any set of overlapped spans. FIG. 17 shows example sets of overlapped spans.

In the example embodiment illustrated in the flowchart of FIG. 26, the network node determines 2600 a CA limit for the UE configuration with monitoring capability, e.g., for UE PDCCH monitoring, based on a set of overlapping spans across scheduling cells. In a further embodiment, the determination 2600 includes determining the set of overlapped spans across scheduling cells as the set which contains a span and all other spans which overlap with the span, with at most one span per scheduling cell. In an alternative or additional embodiment, the set of overlapped spans across the scheduling cells is the set with the largest number of spans and with at most one span per scheduling cell, where any span in the set is at least overlapped with one or more other spans in the set.

Section 4 titled “PDCCH overbooking and dropping” is described below.

Let a UE be configured with N_{cells,r16}^{DL,μ} downlink cells using Rel-16 PDCCH monitoring capability, and with N_{cells,r16}^{DL,(X,Y),μ} of the N_{cells,r16}^{DL,μ} downlink cells using combination (X,Y) for PDCCH monitoring, and having active DL BWP(s) using SCS configuration μ.

Let Mₛ be the number of PDCCH candidates in span s and Cₛ be the number of non-overlapped CCEs in span s. A set R is a set of spans s with at most one span s per scheduling cell. Different examples of further restricting the set R are given in Sections 2 and 3.

In one non-limiting embodiment, PDCCH dropping is performed per set R only on a primary cell (PCell) or Primary secondary cell (PSCell), where the dropping is done if the total number of configured PDCCH candidates or non-overlapped CCEs in set R exceeds the per-span limit, M_{PDCCH}^{max,(X,Y),μ} or C_{PDCCH}^{max,(X,Y),μ}, or the CA limit M_{PDCCH}^{total,(X,Y),μ} or C_{PDCCH}^{total,(X,Y),μ} determined from Sections 2 and 3.

In the example embodiment illustrated in the flowchart of FIG. 27, the during PDCCH monitoring, the UE drops 2700 a PDCCH candidate when a total number of configured PDCCH candidates or non-overlapped control channel elements, CCEs, in a set of spans on a primary cell or primary secondary cell exceeds a per-span limit or exceeds a CA limit. In a further embodiment, the per-span limit and/or the CA limit is determined based on the configuration received from the network node.

An alternative rule is given as follows.

If Σ_{s∈R} Mₛ≤M_{PDCCH}^{total,(X,Y),μ} and Σ_{s∈R} Cₛ≤C_{PDCCH}^{total,(X,Y),μ} for all sets R, the UE is required to monitor all PDCCH candidates. If Σ_{s∈R} Mₛ>M_{PDCCH}^{total,(X,Y),μ} or Σ_{s∈R} Cₛ>C_{PDCCH}^{total,(X,Y),μ}, for some set R, then the UE should drop PDCCH candidates from different spans in R in a predetermined manner. If after dropping candidates, the Σ_{s∈R} Mₛ≤M_{PDCCH}^{total,(X,Y),μ} and Σ_{s∈R} Cₛ≤C_{PDCCH}^{total,(X,Y),μ} for the set R, then the UE monitors the candidates which are not dropped. One example of a predetermined manner is that the UE drops candidates only from spans in the primary cell.

Section 5 titled “DL-sub-slot structure considering UE monitoring limit between two adjacent DL-sub-slots” is now described below.

In the discussion above, PDCCH monitoring burden is considered for a given DL-sub-slot only. For some UE implementation, it may be useful to consider PDCCH monitoring burden between two adjacent DL-sub-slots also, including the two adjacent slots at the slot boundary.

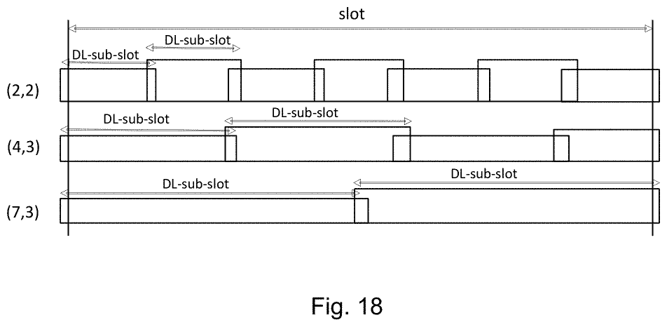

In this case, to avoid overload of PDCCH monitoring in-between two adjacent DL-sub-slots, the DL-sub-slot pattern can be defined such that the two DL-sub-slots overlap, including between slot j and slot (j+1). This is illustrated in FIG. 18. FIG. 18 shows DL-sub-slot structure/pattern for each combination (X,Y) for the purpose of determining Rel-16 CA limit where adjacent DL-sub-slots can overlap.

The CCE limit and BD limit definition across component carriers with Rel-16 monitoring capability is the same as the cases when the DL-sub-slots do not overlap.

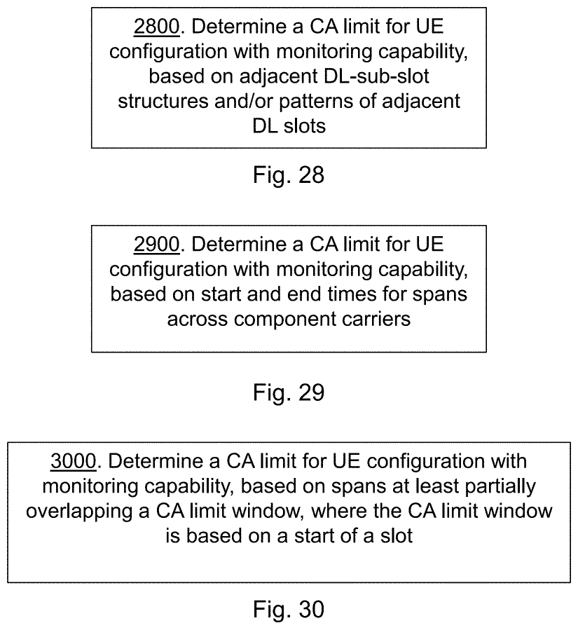

In the example embodiment illustrated in the flowchart of FIG. 28, the network node determines 2800 a CA limit for UE configuration with (for) monitoring capability, based on adjacent DL-sub-slot structures and/or patterns of adjacent DL slots. In a further embodiment, the CA limit is determined 2800 based on adjacent overlapping DL-sub-slot structures and/or patterns of adjacent DL slots located at the slot boundary.

In the following, Section 6 to Section 9 describe the solutions for CA-limit determination based on the concepts of time partitions according to starting and ending of spans and based on the sliding window.

Section 6 titled “Principle of Rel-16 CA limit determination based on span start/end time partitioning” is now described below.

In one non-limiting embodiment, the solution for determining Rel-16 CA limit is based on time partitioning determined by spans starting and ending. The CA limit holds over the spans at least partly overlapping/being present in a time partition. More precisely, the starting and ending over all spans are ordered in increasing order and wherein the time partitions are defined as the time period between start/end time and the next start/end time. For example, if a first span in one component carrier starts and ends at times t₁₁ and t₁₂, respectively, and a second span in another component carrier starts and ends at times t₂₁ and t₂₂, respectively. If t₂₁<t₁₂, then the two spans overlap in time. If the two spans have same time duration, then the ordered start/end times equals {t₁₁, t₂₁, t₁₂, t₂₂} and the set of time partitions equals {[t₁₁, t₂₁[, [t₂₁, t₁₂[, [t₁₂, t₂₂[}. Clearly, the first and second span both at least partly overlap with each one the time partition and hence should obey the CA limit. The notation [a, b[ for the time partitions means that a span that starts at the end time b of a time partitioning is not considered as partly overlapping with the time partition.

In the example embodiment illustrated in the flowchart of FIG. 29, the network node determines 2900 a CA limit for UE configuration with monitoring capability, based on start and end times for spans across component carriers. In a further embodiment, the CA limit is determined for UE configuration for PDCCH monitoring, where the PDCCH monitoring may be Rel-16 PDCCH monitoring.

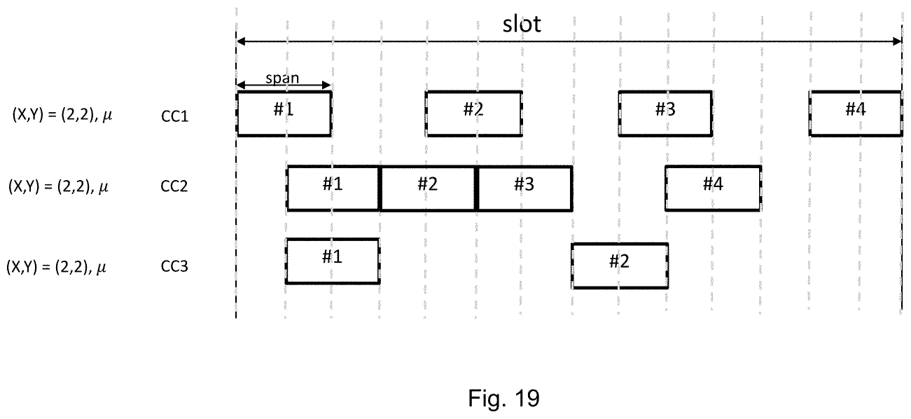

FIG. 19 illustrates a larger example with three component carriers CC1-CC3. In the first time partition, only span #1 of CC1 (partly) overlaps or is present, while in the second time partition, span #1 of all component carriers overlaps, and so on. More particularly, FIG. 19 shows an example of determining time partitions based on start and end times for spans across the component carriers. That is, the CA limit for each (X,Y) and μ, e.g., M_{PDCCH}^{total,(X,Y),μ} or C_{PDCCH}^{total,(X,Y),μ} is applied for any set of spans overlapping/present in a time window, across the active DL BWP(s) of scheduling cell(s) from the N_{cells,r16}^{DL,(X,Y),μ} downlink cells with at most one span per scheduling cell for each set.

Section 7 titled “Principle of Rel-16 CA limit determination based on CA limit window” is now described below.

In one non-limiting embodiment, the solution for determining Rel-16 CA limit is based on spans overlapping a CA limit window. A CA-limit window is defined as a time duration [t₁+Δ, t₂+Δ[, where t₂>t₁ and Δ is a variable. Since CA limit is defined as a limit within a slot, the start of the CA-limit window can, without loss of generality, be the start of the slot and we may assume Δ≥0. The upper range of Δ depends on the length of the slot and the duration of the CA-limit window (i.e., t₂−t₁). If we count time in symbols, then since a slot consists of 14 symbols it is enough to consider spans overlapping the CA-limit window for [t₁+Δ, t₂+Δ[, where Δ=0, 1, . . . , 14−(t₂−t₁).

Duration of the CA window, t₂−t₁ and/or the resolution of the sliding window parameter Δ can be fixed in the specification or depend on UE capability.

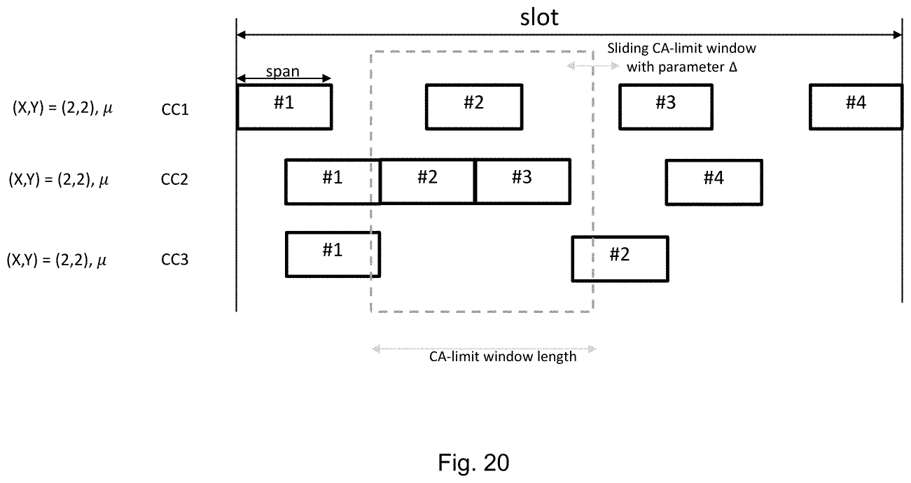

For each location of the CA-limit window the set of spans that at least partly overlap the CA-limit window shall obey the CA limit. FIG. 20 illustrate an example of a location of the CA-limit window wherein span #2 of CC1, span #1-span #3 of CC2 and span #1-span #2 of CC3 overlaps with the CA-limit window and shall obey the CA limit. FIG. 20 shows an example of determining spans that shall obey CA limit based on CA-limit window.

That is, the CA limit for each (X,Y) and μ, e.g., M_{PDCCH}^{total,(X,Y),μ} or C_{PDCCH}^{total,(X,Y),μ} is applied for any set of spans overlapping/residing in any CA-limit window, across the active DL BWP(s) of scheduling cell(s) from the N_{cells,r16}^{DL,(X,Y),μ} downlink cells with at most one span per scheduling cell for each set. By obeying the CA-limit, it means that the UE does not expect to monitor with the sum of PDCCH candidates or non-overlapped CCEs of the set of considered spans more than the CA-limit.

In the example embodiment illustrated in the flowchart of FIG. 30, the network node determines 3000 a CA limit for UE configuration with monitoring capability, based on spans at least partially overlapping a CA limit window, wherein the CA limit window is based on a start of a slot. In a further embodiment, the CA limit is determined for UE configuration for PDCCH monitoring, where the PDCCH monitoring may be Rel-16 PDCCH monitoring. The CA limit may be determined to be applied for any set of spans at least partially overlapping in the CA limit window across an active downlink, DL, at least one bandwidth part, BWP, of at least one scheduling cell from a downlink cells with at most one span per scheduling cell for each set.

Section 8 titled “Principle of Rel-16 CA limit determination irrespectively of span combination” is now described below.

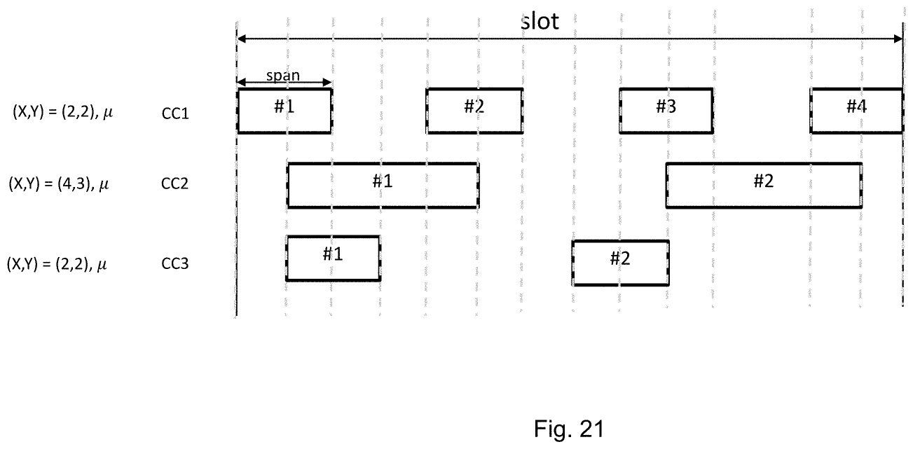

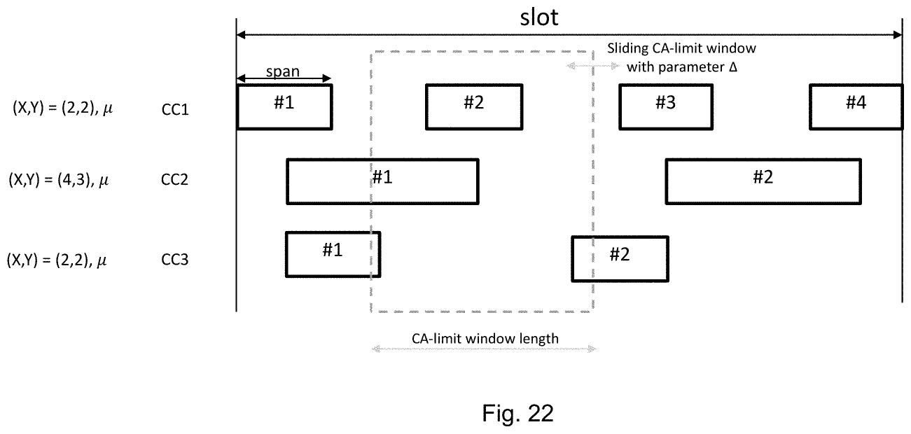

In one non-limiting embodiment, the CA limit holds for overlapping spans irrespectively of span combination (2,2), (4,3) and (7,3). The embodiments in Section 6 and Section 7 can be extended for different span combinations as illustrated in FIG. 21 and FIG. 22 where time partition or the CA-limit window is determined for each SCS μ based on all component carriers regardless of combination (X,Y). FIG. 21 shows an example of time partitions when spans are with different span combination. FIG. 22 shows an example CA-limit window when spans are with different span combination.

In this case, since the CA-limit for each SCS μ is applied per CA-limit window which can include component carriers with different combinations (X,Y), the CA limit needs to be computed differently compared to that in the previous sections. For example, instead of using the span-limit for each (X,Y) to compute the CA-limit for a group of CCs for each (X,Y), the minimum of the span-limits among different combinations (X,Y) can be used instead to compute the CA-limit.

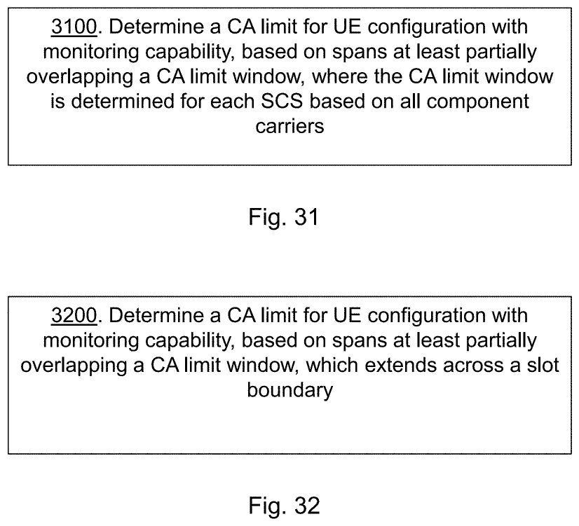

In the embodiment illustrated in the flowchart of FIG. 31, the network node determines 3100 a CA limit for UE configuration with monitoring capability, based on spans at least partially overlapping a CA limit window, where the CA limit window is determined for each SCS μ based on all component carriers. In a further embodiment, the CA limit is determined for UE configuration for PDCCH monitoring, where the PDCCH monitoring may be Rel-16 PDCCH monitoring. In a further embodiment, the CA limit for a group of component carriers, CC, for each of a plurality of combinations (X,Y) is determined 3100 based on a minimum of span-limits among the combinations (X,Y).

In one non-limiting embodiment, if a UE is configured with the number of DL cells for all SCS, Σ_{μ=0}¹ N_{cells,r16}^{DL,μ} larger than the UE reported capability N_{cells}^{cap-r16}, the UE is not required to monitor more than

$${M}_{P D C C H}^{total , , μ} = ⌊ {N}_{cells}^{c a p - r 16} \cdot {min}_{( X , Y )} ( {M}_{P D C C H}^{max , ( X , Y ) , μ} ) \cdot {N}_{cells , rel 16}^{DL , , μ} / {\sum }_{j = 0}^{1} ( {N}_{cells , r 16}^{DL , j} ) ⌋ PDCCH candidates or {C}_{P D C C H}^{total , μ} = ⌊ {N}_{cells}^{c a p - r 16} \cdot {min}_{( X , Y )} ( {C}_{P D C C H}^{max , ( X , Y ) , μ} ) \cdot {N}_{cells , rel 16}^{DL , , μ} / {\sum }_{j = 0}^{1} ( {N}_{cells , r 16}^{DL , j} ) ⌋$$

non-overlapped CCEs, where N_{cells,r16}^{DL,j} is a number of configured cells using Rel-16 PDCCH monitoring capability with SCS configuration j. The CA limit for each p, e.g., M=CH or C_{P} CH is then applied to any set of spans overlapping/present in any time partition or CA-limit window, across the active DL BWP(s) of scheduling cell(s) from the N_{cells,r16}^{DL,μ} downlink cells with at most one span per scheduling cell for each set.

Section 9 titled “Principle of Rel-16 CA limit determination based on CA-limit window crossing slot boundary” is now described below.

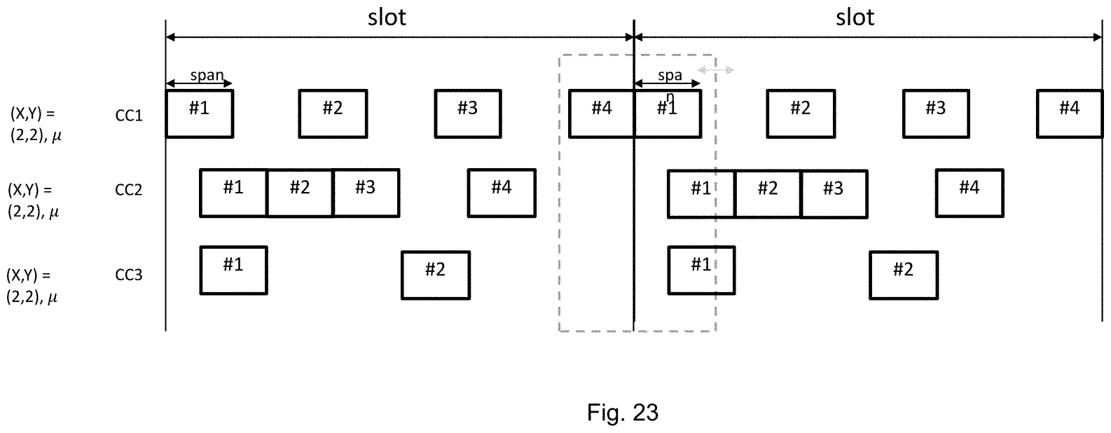

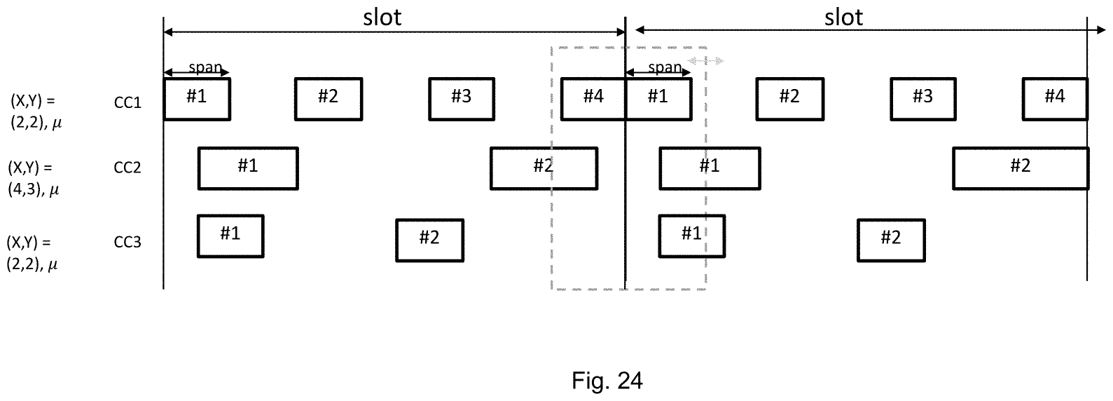

In one non-limiting embodiment the CA limit is determined based on CA-limit window that cross slot boundary. FIG. 23 and FIG. 24 illustrate two examples of locations of CA-limit where a set of spans in different slots overlaps the CA-limit window and shall obey the CA limit. FIG. 23 shows an example CA-limit window crossing slot border. FIG. 24 shows an example CA-limit window crossing slot boundary with spans of different span combinations.

In the embodiment illustrated in the flowchart of FIG. 32, the network node determines 3200 a CA limit for UE configuration with monitoring capability, based on spans at least partially overlapping a CA limit window which extends across a slot boundary. In a further embodiment, the CA limit is determined for UE configuration for PDCCH monitoring, where the PDCCH monitoring may be Rel-16 PDCCH monitoring.

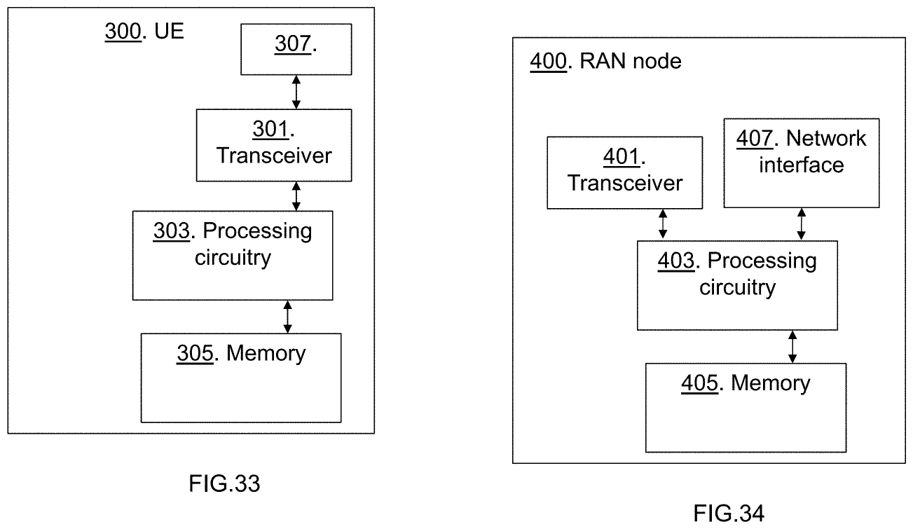

FIG. 33 is a block diagram illustrating elements of a communication device 300 (also referred to as a user equipment (UE), mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. As shown, communication device 300 may include one or more antennas 307, and transceiver circuitry 301 (also referred to as a transceiver) including a transmitter and a receiver configured to provide uplink and downlink radio communications with a base station(s) (e.g., a network node, also referred to as a RAN node) of a radio access network. Communication device 300 may also include processing circuitry 303 (also referred to as a processor) coupled to the transceiver circuitry, and memory circuitry 305 (also referred to as memory) coupled to the processing circuitry. The memory circuitry 305 may include computer readable program code that when executed by the processing circuitry 303 causes the processing circuitry to perform operations according to embodiments disclosed herein. According to other embodiments, processing circuitry 303 may be defined to include memory so that separate memory circuitry is not required. Communication device (UE) may also include an interface (such as a user interface) coupled with processing circuitry 303, and/or communication device (UE) may be incorporated in a vehicle.

As discussed herein, operations of communication device 300 may be performed by processing circuitry 303 and/or transceiver circuitry 301. For example, processing circuitry 303 may control transceiver circuitry 301 to transmit communications through transceiver circuitry 301 over a radio interface to a radio access network node and/or to receive communications through transceiver circuitry 301 from a RAN node over a radio interface. Moreover, modules may be stored in memory circuitry 305, and these modules may provide instructions so that when instructions of a module are executed by processing circuitry 303, processing circuitry 303 performs respective operations (e.g., operations disclosed herein with respect to Example Enumerated Embodiments relating to UEs).

Thus, the UE 300 and/or the processing circuitry 303 may be configured to, during PDCCH monitoring, drop the PDCCH candidate when a total number of configured PDCCH candidates or non-overlapped CCEs in a set of spans on a primary cell or primary secondary cell exceeds a per-span limit or exceeds a carrier aggregation, CA, limit.

FIG. 34 is a block diagram illustrating elements of a radio access network (RAN) node 400 (e.g., base station, eNodeB/eNB, gNodeB/gNB, etc.), configured to provide communications according to embodiments of inventive concepts. As shown, the RAN node 400 includes transceiver circuitry 401 (also referred to as a transceiver) including a transmitter and a receiver configured to provide uplink and downlink radio communications with communication devices and other UEs. The RAN node 400 may include network interface circuitry 407 (also referred to as a network interface) configured to provide communications with other nodes of the RAN and/or core network CN. The RAN node 400 may also include processing circuitry 403 (also referred to as a processor) coupled to the transceiver circuitry, and memory circuitry 405 (also referred to as memory) coupled to the processing circuitry. The memory circuitry 405 may include computer readable program code that when executed by the processing circuitry 403 causes the processing circuitry to perform operations according to embodiments disclosed herein. According to other embodiments, processing circuitry 403 may be defined to include memory so that a separate memory circuitry is not required.

As discussed herein, operations of the RAN node 400 may be performed by processing circuitry 403, network interface 407, and/or transceiver 401. For example, processing circuitry 403 may control transceiver 401 to transmit downlink communications through transceiver 401 over a radio interface to one or more communication device or other UEs and/or to receive uplink communications through transceiver 401 from one or more communication device or other UEs over a radio interface. Similarly, processing circuitry 403 may control network interface 407 to transmit communications through network interface 407 to one or more other network nodes and/or to receive communications through network interface from one or more other network nodes. Moreover, modules may be stored in memory 405, and these modules may provide instructions so that when instructions of a module are executed by processing circuitry 403, processing circuitry 403 performs respective operations (e.g., operations disclosed herein with respect to Example Enumerated Embodiments relating to network nodes).

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node).

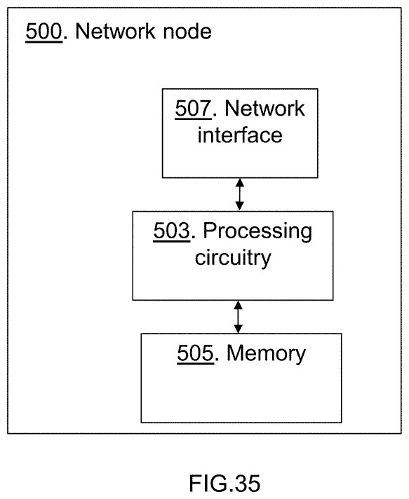

FIG. 35 is a block diagram illustrating elements of a network node 500 of a communication network configured to provide cellular communication according to embodiments of inventive concepts. As shown, the network node 500 node may include network interface circuitry 507 (also referred to as a network interface) configured to provide communications with other nodes of the core network and/or the radio access network RAN. The network node 500 may also include a processing circuitry 503 (also referred to as a processor) coupled to the network interface circuitry, and memory circuitry 505 (also referred to as memory) coupled to the processing circuitry. The memory circuitry 505 may include computer readable program code that when executed by the processing circuitry 503 causes the processing circuitry to perform operations according to embodiments disclosed herein. According to other embodiments, processing circuitry 503 may be defined to include memory so that a separate memory circuitry is not required.

As discussed herein, operations of the network node 500 may be performed by processing circuitry 503 and/or network interface circuitry 507. For example, processing circuitry 503 may control network interface circuitry 507 to transmit communications through network interface circuitry 507 to one or more other network nodes and/or to receive communications through network interface circuitry from one or more other network nodes. Moreover, modules may be stored in memory 505, and these modules may provide instructions so that when instructions of a module are executed by processing circuitry 503, processing circuitry 503 performs respective operations (e.g., operations disclosed herein with respect to Example Enumerated Embodiments relating to network nodes).

Thus, according to embodiments herein it is herein provided the network node 500, the radio network node 400 and/or the processing circuitry 403 or 503. The network node, the radio network node and/or the processing circuitry is configured to determine the CA limit for the UE configuration with monitoring capability, based on: the DL-sub-slot structure and/or the pattern of a DL slot; the set of overlapping spans across scheduling cells; start and end times for spans across component carriers; and/or spans at least partially overlapping a CA limit window. The CA limit may be determined for UE configuration for PDCCH monitoring.

The UE configuration may comprise at least one of: SCS for PDCCH monitoring; a combination of minimum time (X) separation between the start of two PDCCH monitoring spans and maximum length (Y) of the spans; and number of component carriers configured for PDCCH monitoring. The DL-sub-slot structure and/or the pattern may be determined for each combination (X,Y) and SCS configuration μ based on PDCCH monitoring span patterns of N_{cells,r16}^{DL,(X,Y),μ} downlink, DL, cells and/or component carriers associated with the combination (X,Y). The determination of the DL-sub-slot pattern for the combination (X,Y), may comprise generating a bitmap b(l), wherein 0<=l<=13, an where b(l)=1 if symbol l of a slot is the starting symbol of a monitoring span of the relevant component carriers, and b(l)=0 otherwise. A first DL sub-slot in the DL-sub-slot pattern may begin at the smallest 1 for which b(l)=1, and has duration T symbols, and the next DL-sub-slot in the DL-sub-slot pattern may begin at the smallest 1 not included in the previous DL-sub-slot(s) for which b(l)=1.

The DL-sub-slot structure and/or pattern may be fixed for a given combination of the combination and μ {(X,Y), μ}, and does not vary with the actual monitoring span pattern of the component carriers, wherein “μ” is the SCS configuration. One DL-sub-slot structure and/or pattern may defined for each combination (X,Y) corresponding to a UE reported capability for Rel-16 PDCCH monitoring regardless of the numerology μ, wherein “μ” is the SCS configuration. A same DL-sub-slot structure and/or pattern may be defined for each combination (X,Y) of a given numerology μ, wherein “μ” is the SCS configuration. One or more DL-sub-slot structures and/or patterns are defined for each combination (X,Y) and DL numerology μ, corresponding to a UE reported capability for Rel-16 PDCCH monitoring, wherein “X” is the minimum separation between the start of two PDCCH monitoring spans, and wherein “μ” is the subcarrier spacing, SCS, configuration.

When the UE is configured with multiple DL cells using Rel-16 PDCCH monitoring capability associated with combination (X,Y), the same DL-sub-slot structure and/or pattern corresponding to combination (X,Y) may be applied to all the scheduling cells associated with the combination (X,Y).

When the UE is configured with a number of DL cells for all SCS Σ_{μ=0}¹ N_{cells,r16}^{DL,μ} smaller than or equal to a UE reported capability N_{cells}^{cap-r16}, it may not be required by the UE to monitor more than M_{PDCCH}^{max,(X,Y),μ} PDCCH candidates per span or C_{PDCCH}^{max,(X,Y),μ} non-overlapped CCEs per span on the active DL one or more BWPs of one or more scheduling cells from the N_{cells,r16}^{DL,(X,Y),μ} downlink cells.

When the UE is configured with a number of DL cells for all SCS, Σ_{μ=0}¹ N_{cells,r16}^{DL,μ} larger than a UE reported capability N_{cells}^{cap-r16}, it may not be required by the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans present in the same DL-sub-slot across the active DL BWP(s) of scheduling cell(s) from N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein the span is present in a DL-sub-slot if at least one symbol of the span is in the DL-sub-slot or overlaps with the DL-sub-slot.

When the UE is configured with a number of DL cells for all SCS, Σ_{μ=0}¹ N_{cells,r16}^{DL,μ} larger than a UE reported capability N_{cells}^{cap-r16}, it may not be required by the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans starting in the same DL-sub-slot across the active DL at least one BWP of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein the span is starting in a DL-sub-slot if the first symbol of the span is in the DL-sub-slot.

When the UE is configured with a number of DL cells for all SCS, Σ_{μ=0}¹ N_{cells,r16}^{DL,μ} larger than a UE reported capability N_{cells}^{cap-r16}, it may not be required by the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non- overlapped CCEs for any set of spans present in the same DL-sub-slot across the active DL at least one BWPs of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with subcarrier spacing, SCS, configuration j, and wherein a span is present in a DL-sub-slot if at least one symbol of the span is in the DL-sub-slot or overlaps with the DL-sub-slot.

When the UE is configured with a number of DL cells for all SCS, Σ_{μ=0}¹ N_{cells,r16}^{DL,μ} larger than a UE reported capability N_{cells}^{cap-r16}, it may not be required by the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non- overlapped CCEs for any set of spans starting in the same DL-sub-slot across the active DL at least one BWPs of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein a span is starting in a DL-sub-slot if the first symbol of the span is in the DL-sub-slot.

When the UE is configured with a number of DL cells for all subcarrier spacing, SCS, Σ_{μ=0}¹ N_{cells,r16}^{DL,μ} larger than a UE reported capability N_{cells}^{cap-r16}, it may not be required by the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped control channel elements, CCEs, for any set of spans ending in the same DL-sub-slot across the active DL at least one BWP of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with subcarrier spacing, SCS, configuration j, and wherein a span is ending in a DL-sub-slot if at least the last symbol of the span is in the DL-sub-slot.

For each scheduled cell, it may not be required by the UE to monitor on the active DL BWP with SCS configuration μ of the scheduling cell from the N_{cells,r16}^{DL,(X,Y),μ} downlink cells more than min(M_{PDCCH}^{max,(X,Y),μ}, M_{PDCCH}^{total,(X,Y),μ}) PDCCH candidates or more than min(C_{PDCCH}^{max,(X,Y),μ}, C_{PDCCH}^{total,(X,Y),μ}) non-overlapped CCEs per span.

The CA limit may be determined based on adjacent DL-sub-slot structures and/or patterns of adjacent DL slots. The CA limit may for example be determined based on the adjacent DL-sub-slot structures and/or patterns of adjacent DL slots located at the slot boundary.

The CA limit window may be based on a start of a slot. The CA limit window may be determined for each SCS based on all component carriers. The CA limit for a group of CCs, for each of a plurality of combinations (X,Y) is determined (3100) based on a minimum of span-limits among the combinations (X,Y). The CA limit window may extend across a slot boundary. It should be noted that the CA limit may be determined based on a start of a slot, and the CA limit may be applied for any set of spans at least partially overlapping in the CA limit window across an active DL, at least one BWP, of at least one scheduling cell from a downlink cells with at most one span per scheduling cell for each set.

The CA limit may be determined based on the set of overlapping spans across the scheduling cells and the set of overlapping spans across the scheduling cells is determined as a set which contains a span and all other spans which overlap with the span, with at most one span per scheduling cell. Additionally or alternatively, the set of overlapping spans may be determined as a set with the largest number of spans and with at most one span per scheduling cell, where any span in the set is at least overlapped with one or more other spans in the set.

Example Enumerated Embodiments are discussed below.

1. A method by a network node comprising:

determining (2500) a carrier aggregation, CA, limit for user equipment, UE, configuration with monitoring capability, based on a downlink, DL-sub-slot structure and/or pattern of a DL slot.

2. The method of Embodiment 1, wherein the CA limit is determined for UE configuration for physical downlink control channel, PDCCH, monitoring.

3. The method of Embodiment 2, wherein the CA limit is determined for UE configuration for Rel-16 PDCCH monitoring.

4. The method of any of Embodiments 1 to 3, wherein the UE configuration comprises at least one of: subcarrier spacing, SCS, for PDCCH monitoring; combination of minimum time (X) separation between the start of two PDCCH monitoring spans and maximum length (Y) of the spans; and number of component carriers configured for PDCCH monitoring.

5. The method of Embodiment 4, wherein the DL-sub-slot structure and/or pattern is determined for each combination (X,Y) and subcarrier spacing, SCS, configuration μ based on PDCCH monitoring span patterns of N_{cells,r16}^{DL,(X,Y),μ} downlink, DL, cells and/or component carriers associated with the combination (X,Y).

6. The method of Embodiment 5, wherein the determination of the DL-sub-slot pattern for the combination (X,Y), comprises generating a bitmap b(l), 0<=l<=13, where b(l)=1 if symbol l of a slot is the starting symbol of a monitoring span of the relevant component carriers, b(l)=0 otherwise.

7. The method of Embodiment 6, wherein the first DL sub-slot in the DL-sub-slot pattern begins at the smallest 1 for which b(l)=1, and has duration T symbols, and the next DL-sub-slot in the DL-sub-slot pattern begins at the smallest 1 not included in the previous DL-sub-slot(s) for which b(l)=1.

8. The method of any of Embodiments 1 to 7, wherein the DL-sub-slot structure and/or pattern is fixed for a given combination of {(X,Y), μ}, and does not vary with the actual monitoring span pattern of the component carriers, wherein “μ” is the subcarrier spacing, SCS, configuration.

9. The method of any of Embodiments 1 to 8, wherein one DL-sub-slot structure and/or pattern is defined for each combination (X,Y) corresponding to a UE reported capability for Rel-16 PDCCH monitoring regardless of the numerology μ, wherein “μ” is the subcarrier spacing, SCS, configuration.

10. The method of any of Embodiments 1 to 9, wherein a same DL-sub-slot structure and/or pattern is defined for each combination (X,Y) of a given numerology μ, wherein “μ” is the subcarrier spacing, SCS, configuration.

11. The method of any of Embodiments 1 to 10, wherein one or more DL-sub-slot structures and/or patterns are defined for each combination (X,Y) and DL numerology μ, corresponding to a UE reported capability for Rel-16 PDCCH monitoring, wherein “X” is the minimum separation between the start of two PDCCH monitoring spans.

12. The method of any of Embodiments 1 to 11, wherein one or more DL-sub-slot structures and/or patterns are defined for each combination (X,Y) and DL numerology μ, corresponding to a UE reported capability for Rel-16 PDCCH monitoring, wherein “μ” is the subcarrier spacing, SCS, configuration.

13. The method of any of Embodiments 1 to 12, wherein when the UE is configured with multiple DL cells using Rel-16 PDCCH monitoring capability associated with combination (X,Y), the same DL-sub-slot structure and/or pattern corresponding to combination (X,Y) is applied to all the scheduling cells associated with the combination (X,Y).

14. The method of any of Embodiments 1 to 13, wherein when the UE is configured with a number of DL cells for all subcarrier spacing, SCS, Σ_{μ=0}¹ N_{cells,r16}^{DL,μ} smaller than or equal to a UE reported capability N_{cells}^{cap-r16}, the method does not require the UE to monitor more than M_{PDCCH}^{max,(X,Y),μ} PDCCH candidates per span or C_{PDCCH}^{max,(X,Y),μ} non-overlapped control channel elements, CCEs, per span on the active DL one or more BandWidth Parts, BWPs of one or more scheduling cells from the N_{cells,r16}^{DL,(X,Y),μ} downlink cells.

15. The method of any of Embodiments 1 to 14, wherein when the UE is configured with a number of DL cells for all SCS, Σ_{μ=0}¹ N_{cells,r16}^{DL,μ} larger than a UE reported capability N_{cells}^{cap-r16}, the method does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans present in the same DL-sub-slot across the active DL BWP(s) of scheduling cell(s) from N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein the span is present in a DL-sub-slot if at least one symbol of the span is in the DL-sub-slot or overlaps with the DL-sub-slot.

16. The method of any of Embodiments 1 to 15, wherein when the UE is configured with a number of DL cells for all SCS, Σ_{μ=0}¹ N_{cells,r16}^{DL,μ} larger than a UE reported capability N_{cells}^{cap-r16}, the method does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans starting in the same DL-sub-slot across the active DL at least one BandWidth Part, BWP, of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with subcarrier spacing, SCS, configuration j, and wherein the span is starting in a DL-sub-slot if the first symbol of the span is in the DL-sub-slot.

17. The method of any of Embodiments 1 to 16, wherein when the UE is configured with a number of DL cells for all SCS, Σ_{μ=0}¹ N_{cells,r16}^{DL,μ} larger than a UE reported capability N_{cells}^{cap-r16}, the method does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans present in the same DL-sub-slot across the active DL at least one BandWidth Parts, BWP, of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with subcarrier spacing, SCS, configuration j, and wherein a span is present in a DL-sub-slot if at least one symbol of the span is in the DL-sub-slot or overlaps with the DL-sub-slot.

18. The method of any of Embodiments 1 to 17, wherein when the UE is configured with a number of DL cells for all SCS, Σ_{μ=0}¹ N_{cells,r16}^{DL,μ} larger than a UE reported capability N_{cells}^{cap-r16}, the method does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans starting in the same DL-sub-slot across the active DL at least one BandWidth Parts, BWPs, of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein a span is starting in a DL-sub-slot if the first symbol of the span is in the DL-sub-slot.

19. The method of any of Embodiments 1 to 18, wherein when the UE is configured with a number of DL cells for all subcarrier spacing, SCS, Σ_{μ=0}¹ N_{cells,r16}^{DL,μ} larger than a UE reported capability N_{cells}^{cap-r16}, the method does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped control channel elements, CCEs, for any set of spans ending in the same DL-sub-slot across the active DL at least one BandWidth Part, BWP, of at least one scheduling cell from the N_{cells,r16}^{DL,j} downlink cells with at most one span per scheduling cell for each set, wherein N_{cells,r16}^{DL,j} is a number of configured cells using Rel-16 PDCCH monitoring capability with subcarrier spacing, SCS, configuration j, and wherein a span is ending in a DL-sub-slot if at least the last symbol of the span is in the DL-sub-slot.

20. The method of any of Embodiments 1 to 19, wherein for each scheduled cell, the method does not require the UE to monitor on the active DL BandWidth Part, BWP, with subcarrier spacing, SCS, configuration μ of the scheduling cell from the N_{cells,r16}^{DL,(X,Y),μ} downlink cells more than min(M_{PDCCH}^{max,(X,Y),μ}, M_{PDCCH}^{total,(X,Y),μ}) PDCCH candidates or more than min(C_{PDCCH}^{max,(X,Y),μ}, C_{PDCCH}^{total,(X,Y),μ}) non-overlapped CCEs per span.

21. The method of any of Embodiments 1 to 20, wherein the determination of the CA limit for UE configuration with monitoring capability is based on overlapping spans across scheduling cells.

22. A computer program product comprising a non-transitory storage medium storing program code to be executed by processing circuitry of a network node, whereby execution of the program code causes the network node to perform operations according to any of Embodiments 1 to 21.

23. A method by a network node comprising;

determining (2600) a carrier aggregation, CA, limit for user equipment, UE, configuration with monitoring capability, based on a set of overlapping spans across scheduled cells.

24. The method of Embodiment 23, wherein the determination (2600) comprises determining the set of overlapped spans across scheduling cells as the set which contains a span and all other spans which overlap with the span, with at most one span per scheduling cell.

25. The method of any of Embodiments 23 to 24, the set of overlapped spans across the scheduling cells is the set with the largest number of spans and with at most one span per scheduling cell, where any span in the set is at least overlapped with one or more other spans in the set.

26. A computer program product comprising a non-transitory storage medium storing program code to be executed by processing circuitry of a network node, whereby execution of the program code causes the network node to perform operations according to any of Embodiments 23 to 25.

27. A method by a user equipment, UE, comprising: during physical downlink control channel, PDCCH, monitoring, dropping (2700) a PDCCH candidate when a total number of configured PDCCH candidates or non-overlapped control channel elements, CCEs, in a set of spans on a primary cell or primary secondary cell exceeds a per-span limit or exceeds a carrier aggregation, CA, limit.

28. A computer program product comprising a non-transitory storage medium storing program code to be executed by processing circuitry of a UE, whereby execution of the program code causes the UE to perform operations according to Embodiment 27.

29. A method by a network node comprising: determining (2800) a carrier aggregation, CA, limit for user equipment, UE, configuration with monitoring capability, based on adjacent downlink, DL-sub-slot structures and/or patterns of adjacent DL slots.

30. The method of Embodiment 29, wherein:

the CA limit is determined (2800) based on adjacent overlapping DL-sub-slot structures and/or patterns of adjacent DL slots located at the slot boundary.

31. A computer program product comprising a non-transitory storage medium storing program code to be executed by processing circuitry of a network node, whereby execution of the program code causes the network node to perform operations according to any of Embodiments 29 to 30.

32. A method by a network node comprising: determining (2900) a carrier aggregation, CA, limit for user equipment, UE, configuration with monitoring capability, based on start and end times for spans across component carriers.

33. The method of Embodiment 32, wherein the CA limit is determined for UE configuration for physical downlink control channel, PDCCH, monitoring.

34. The method of Embodiment 33, wherein the CA limit is determined for UE configuration for Rel-16 PDCCH monitoring.

35. A computer program product comprising a non-transitory storage medium storing program code to be executed by processing circuitry of a network node, whereby execution of the program code causes the network node to perform operations according to any of Embodiments 32 to 34.

36. A method by a network node comprising: determining (3000) a carrier aggregation, CA, limit for user equipment, UE, configuration with monitoring capability, based on spans at least partially overlapping a CA limit window, wherein the CA limit window is based on a start of a slot.

37. The method of Embodiment 36, wherein the CA limit is applied for any set of spans at least partially overlapping in the CA limit window across an active downlink, DL, at least one bandwidth part, BWP, of at least one scheduling cell from a downlink cells with at most one span per scheduling cell for each set.

38. A computer program product comprising a non-transitory storage medium storing program code to be executed by processing circuitry of a network node, whereby execution of the program code causes the network node to perform operations according to any of Embodiments 36 to 37.

39. A method by a network node comprising: determining (3100) a carrier aggregation, CA, limit for user equipment, UE, configuration with monitoring capability, based on spans at least partially overlapping a CA limit window, wherein the CA limit window is determined for each subcarrier spacing, SCS, μ based on all component carriers.

40. The method of Embodiment 39, wherein the CA limit is determined for UE configuration for physical downlink control channel, PDCCH, monitoring.

41. The method of Embodiment 40, wherein the CA limit is determined for UE configuration for Rel-16 PDCCH monitoring.

42. The method of any of Embodiments 39 to 41, wherein the CA limit for a group of component carriers, CC, for each of a plurality of combinations (X,Y) is determined (3100) based on a minimum of span-limits among the combinations (X,Y).

43. A computer program product comprising a non-transitory storage medium storing program code to be executed by processing circuitry of a network node, whereby execution of the program code causes the network node to perform operations according to any of Embodiments 39 to 42.

44. A method by a network node comprising: determining (3200) a carrier aggregation, CA, limit for user equipment, UE, configuration with monitoring capability, based on spans at least partially overlapping a CA limit window which extends across a slot boundary.

45. The method of Embodiment 44, wherein the CA limit is determined for UE configuration for physical downlink control channel, PDCCH, monitoring.

46. The method of Embodiment 45, wherein the CA limit is determined for UE configuration for Rel-16 PDCCH monitoring.

47. A computer program product comprising a non-transitory storage medium storing program code to be executed by processing circuitry of a network node, whereby execution of the program code causes the network node to perform operations according to any of Embodiments 44 to 46.

48. A network node configured to:

determine a carrier aggregation, CA, limit for user equipment, UE, configuration with monitoring capability, based on a downlink, DL-sub-slot structure and/or pattern of a DL slot.

49. The network node of Embodiment 48, further configured to perform the method of any of Embodiments 2 to 21.

50. A network node configured to:

determine a carrier aggregation, CA, limit for user equipment, UE, configuration with monitoring capability, based on a set of overlapping spans across scheduled cells.

51. The network node of Embodiment 50, further configured to perform the method of any of Embodiments 23 to 25.

52. A user equipment, UE, configured to:

during physical downlink control channel, PDCCH, monitoring, drop a PDCCH candidate when a total number of configured PDCCH candidates or non-overlapped control channel elements, CCEs, in a set of spans on a primary cell or primary secondary cell exceeds a per-span limit or exceeds a carrier aggregation, CA, limit.

53. The network node of Embodiment 50, further configured to perform the method of Embodiment 52.

54. A network node configured to:

determine a carrier aggregation, CA, limit for user equipment, UE, configuration with monitoring capability, based on adjacent downlink, DL-sub-slot structures and/or patterns of adjacent DL slots.

55. The network node of Embodiment 54, further configured to perform the method of any of Embodiments 29 to 30.

56. A network node configured to:

determine a carrier aggregation, CA, limit for user equipment, UE, configuration with monitoring capability, based on start and end times for spans across component carriers.

57. The network node of Embodiment 56, further configured to perform the method of any of Embodiments 32 to 34.

58. A network node configured to:

determine a carrier aggregation, CA, limit for user equipment, UE, configuration with monitoring capability, based on spans at least partially overlapping a CA limit window, wherein the CA limit window is based on a start of a slot.

59. The network node of Embodiment 58, further configured to perform the method of any of Embodiments 36 to 37.

60. A network node configured to:

determine a carrier aggregation, CA, limit for user equipment, UE, configuration with monitoring capability, based on spans at least partially overlapping a CA limit window, wherein the CA limit window is determined for each subcarrier spacing, SCS, μ based on all component carriers.

61. The network node of Embodiment 60, further configured to perform the method of any of Embodiments 39 to 42.

62. A network node configured to:

determine a carrier aggregation, CA, limit for user equipment, UE, configuration with monitoring capability, based on spans at least partially overlapping a CA limit window which extends across a slot boundary.

63. The network node of Embodiment 62, further configured to perform the method of any of Embodiments 44 to 46.

Explanations are provided below for various abbreviations/acronyms used in the present disclosure.

| Abbreviation | Explanation |
|---|---|
| 3GPP | 3rd Generation Partnership Project |
| BD | Blind decode |
| BWP | BandWidth Part |
| CA | Carrier aggregation |
| CC | Component carrier |
| CCE | Control channel element |
| CORESET | Control resource set |
| CSS | Common search space |
| DL | Downlink |
| eMBB | enhanced Mobile BroadBand |
| gNB | next Generation NodeB |
| NR | New Radio |
| PDCCH | Physical downlink control channel |
| PCell | Primary cell |
| PSCell | Primary secondary cell |
| SCS | Subcarrier spacing |
| URLLC | Ultra-Reliable Low-Latency Communication |
| USS | UE-specific search space |

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

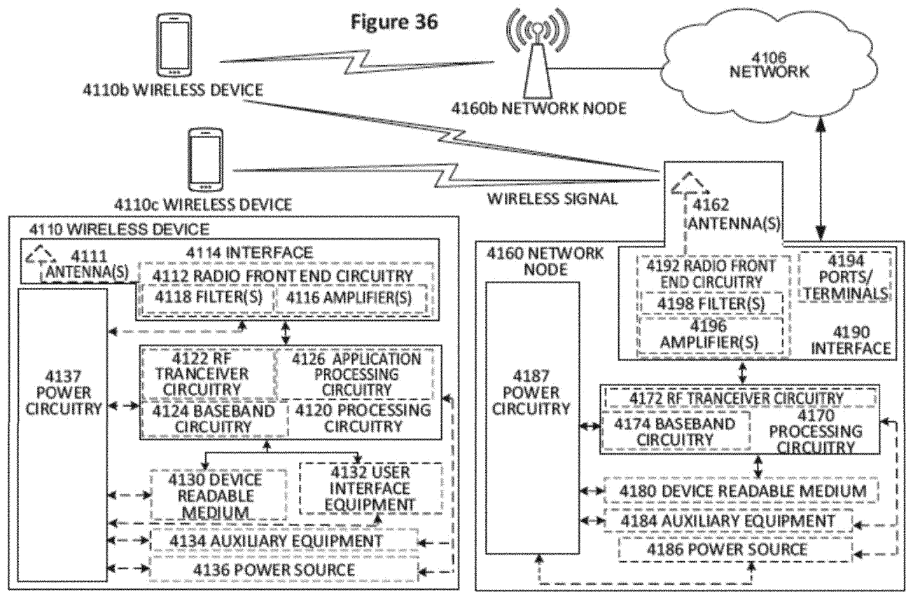

FIG. 36 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 36. For simplicity, the wireless network of FIG. 36 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 36, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 36 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and an RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4192 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 36 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4112 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

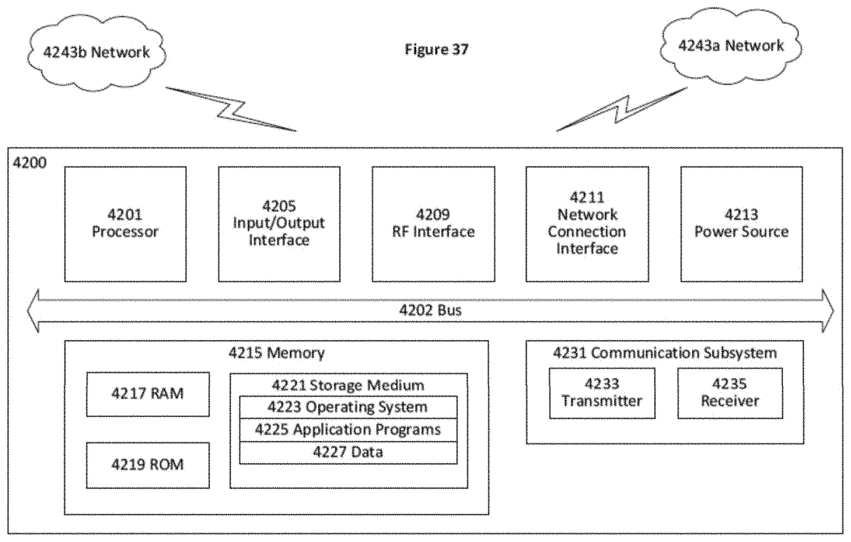

FIG. 37 illustrates a communication device, e.g., user equipment, in accordance with some embodiments.

FIG. 37 illustrates one embodiment of a communication device, such as a UE, in accordance with various aspects described herein. As used herein, a user equipment type of communication device or UE may not necessarily have a user in the sense of a human user who owns and/or operates the relevant device. Instead, a UE type of communication device may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 42200 may be any UE identified by the 3rd Generation Partnership Project (3GPP), including a NB-IoT UE, a machine type communication (MTC) UE, and/or an enhanced MTC (eMTC) UE. UE 4200, as illustrated in FIG. 37, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 37 is a communication device the components discussed herein are equally applicable to a WD, and vice-versa.

In FIG. 37, UE 4200 includes processing circuitry 4201 that is operatively coupled to input/output interface 4205, radio frequency (RF) interface 4209, network connection interface 4211, memory 4215 including random access memory (RAM) 4217, read-only memory (ROM) 4219, and storage medium 4221 or the like, communication subsystem 4231, power source 4213, and/or any other component, or any combination thereof. Storage medium 4221 includes operating system 4223, application program 4225, and data 4227. In other embodiments, storage medium 4221 may include other similar types of information. Certain UEs may utilize all of the components shown in FIG. 37, or only a subset of the components. The level of integration between the components may vary from one UE to another UE. Further, certain UEs may contain multiple instances of a component, such as multiple processors, memories, transceivers, transmitters, receivers, etc.

In FIG. 37, processing circuitry 4201 may be configured to process computer instructions and data. Processing circuitry 4201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 4201 may include two central processing units (CPUs). Data may be information in a form suitable for use by a computer.

In the depicted embodiment, input/output interface 4205 may be configured to provide a communication interface to an input device, output device, or input and output device. UE 4200 may be configured to use an output device via input/output interface 4205. An output device may use the same type of interface port as an input device. For example, a USB port may be used to provide input to and output from UE 4200. The output device may be a speaker, a sound card, a video card, a display, a monitor, a printer, an actuator, an emitter, a smartcard, another output device, or any combination thereof. UE 4200 may be configured to use an input device via input/output interface 4205 to allow a user to capture information into UE 4200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 37, RF interface 4209 may be configured to provide a communication interface to RF components such as a transmitter, a receiver, and an antenna. Network connection interface 4211 may be configured to provide a communication interface to network 4243a. Network 4243a may encompass wired and/or wireless networks such as a local-area network (LAN), a wide-area network (WAN), a computer network, a wireless network, a telecommunications network, another like network or any combination thereof. For example, network 4243a may comprise a Wi-Fi network. Network connection interface 4211 may be configured to include a receiver and a transmitter interface used to communicate with one or more other devices over a communication network according to one or more communication protocols, such as Ethernet, TCP/IP, SONET, ATM, or the like. Network connection interface 4211 may implement receiver and transmitter functionality appropriate to the communication network links (e.g., optical, electrical, and the like). The transmitter and receiver functions may share circuit components, software or firmware, or alternatively may be implemented separately.

RAM 4217 may be configured to interface via bus 4202 to processing circuitry 4201 to provide storage or caching of data or computer instructions during the execution of software programs such as the operating system, application programs, and device drivers. ROM 4219 may be configured to provide computer instructions or data to processing circuitry 4201. For example, ROM 4219 may be configured to store invariant low-level system code or data for basic system functions such as basic input and output (I/O), startup, or reception of keystrokes from a keyboard that are stored in a non-volatile memory. Storage medium 4221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4221 may be configured to include operating system 4223, application program 4225 such as a web browser application, a widget or gadget engine or another application, and data file 4227. Storage medium 4221 may store, for use by UE 4200, any of a variety of various operating systems or combinations of operating systems.

Storage medium 4221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4221 may allow UE 4200 to access computer-executable instructions, application programs or the like, stored on transitory or non-transitory memory media, to off-load data, or to upload data. An article of manufacture, such as one utilizing a communication system may be tangibly embodied in storage medium 4221, which may comprise a device readable medium.

In FIG. 37, processing circuitry 4201 may be configured to communicate with network 4243b using communication subsystem 4231. Network 4243a and network 4243b may be the same network or networks or different network or networks. Communication subsystem 4231 may be configured to include one or more transceivers used to communicate with network 4243b. For example, communication subsystem 4231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 4233 and/or receiver 4235 to implement transmitter or receiver functionality, respectively, appropriate to the RAN links (e.g., frequency allocations and the like). Further, transmitter 4233 and receiver 4235 of each transceiver may share circuit components, software or firmware, or alternatively may be implemented separately.

In the illustrated embodiment, the communication functions of communication subsystem 4231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4231 may include cellular communication, Wi-Fi communication, Bluetooth communication, and GPS communication. Network 4243b may encompass wired and/or wireless networks such as a local-area network (LAN), a wide-area network (WAN), a computer network, a wireless network, a telecommunications network, another like network or any combination thereof. For example, network 4243b may be a cellular network, a Wi-Fi network, and/or a near-field network. Power source 4213 may be configured to provide alternating current (AC) or direct current (DC) power to components of UE 4200.

The features, benefits and/or functions described herein may be implemented in one of the components of UE 4200 or partitioned across multiple components of UE 4200. Further, the features, benefits, and/or functions described herein may be implemented in any combination of hardware, software or firmware. In one example, communication subsystem 4231 may be configured to include any of the components described herein. Further, processing circuitry 4201 may be configured to communicate with any of such components over bus 4202. In another example, any of such components may be represented by program instructions stored in memory that when executed by processing circuitry 4201 perform the corresponding functions described herein. In another example, the functionality of any of such components may be partitioned between processing circuitry 4201 and communication subsystem 4231. In another example, the non-computationally intensive functions of any of such components may be implemented in software or firmware and the computationally intensive functions may be implemented in hardware.

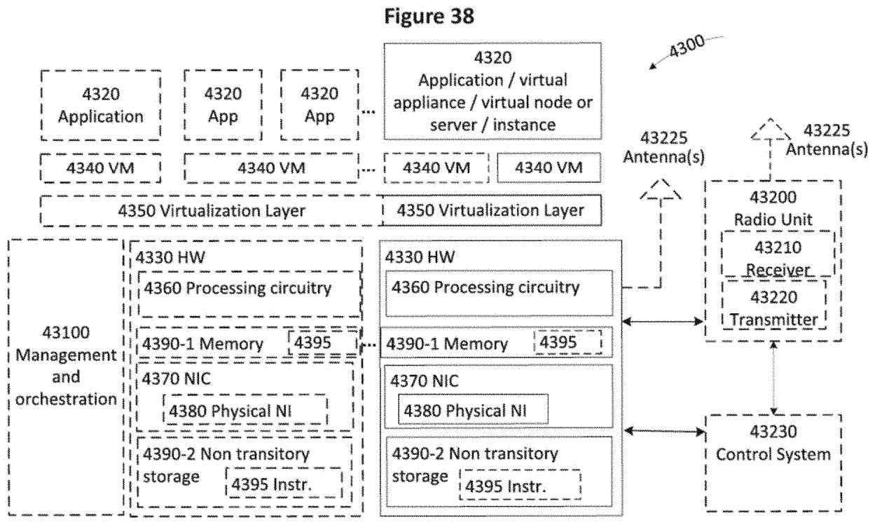

FIG. 38 illustrates a virtualization environment in accordance with some embodiments.

FIG. 38 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340 comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 38, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 38.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be affected with the use of control system 43230 which may alternatively be used for communication between the hardware nodes 4330 and radio units 43200.

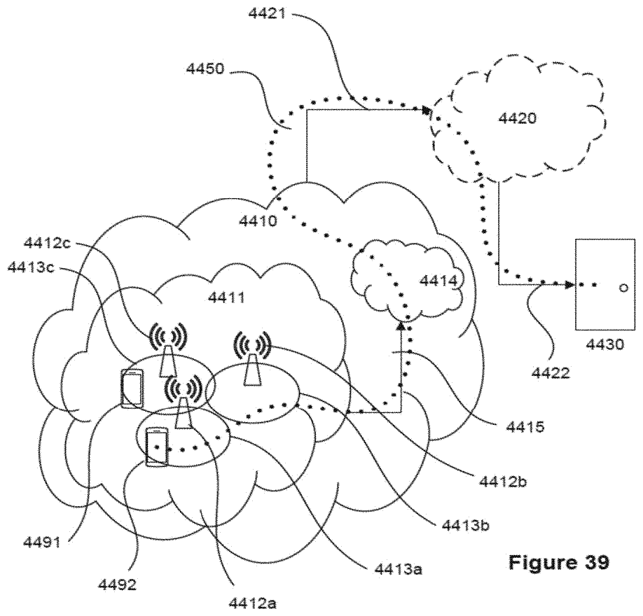

FIG. 39 illustrates a telecommunication network connected via an intermediate network to a host computer in accordance with some embodiments.

With reference to FIG. 39, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 39 as a whole enables connectivity between the connected UEs 4491, 4492 and host computer 4430. The connectivity may be described as an over-the-top (OTT) connection 4450. Host computer 4430 and the connected UEs 4491, 4492 are configured to communicate data and/or signaling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

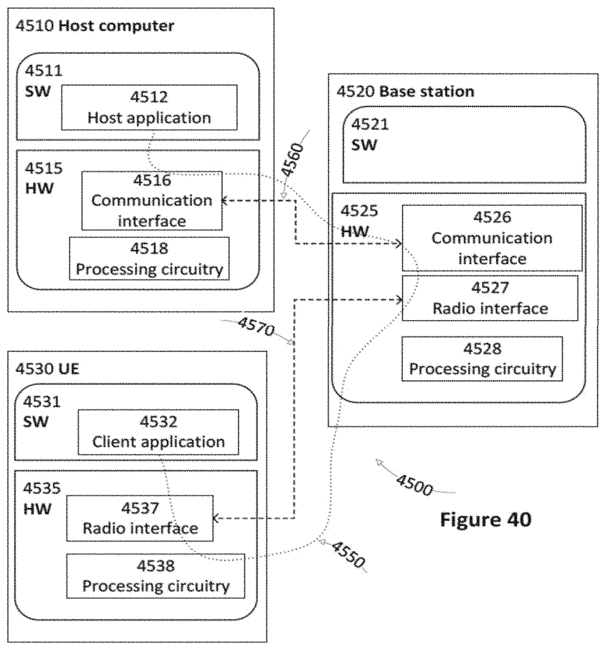

FIG. 40 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 40. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities. In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 40) served by base station 4520. Communication interface 4526 may be configured to facilitate connection 4560 to host computer 4510. Connection 4560 may be direct or it may pass through a core network (not shown in FIG. 12) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. The hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

It is noted that host computer 4510, base station 4520 and UE 4530 illustrated in FIG. 40 may be similar or identical to host computer 4430, one of base stations 4412a, 4412b, 4412c and one of UEs 4491, 4492 of FIG. 39 respectively. This is to say, the inner workings of these entities may be as shown in FIG. 40 and independently, the surrounding network topology may be that of FIG. 39.

In FIG. 40, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signaling facilitating host computer 4510's measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors etc.

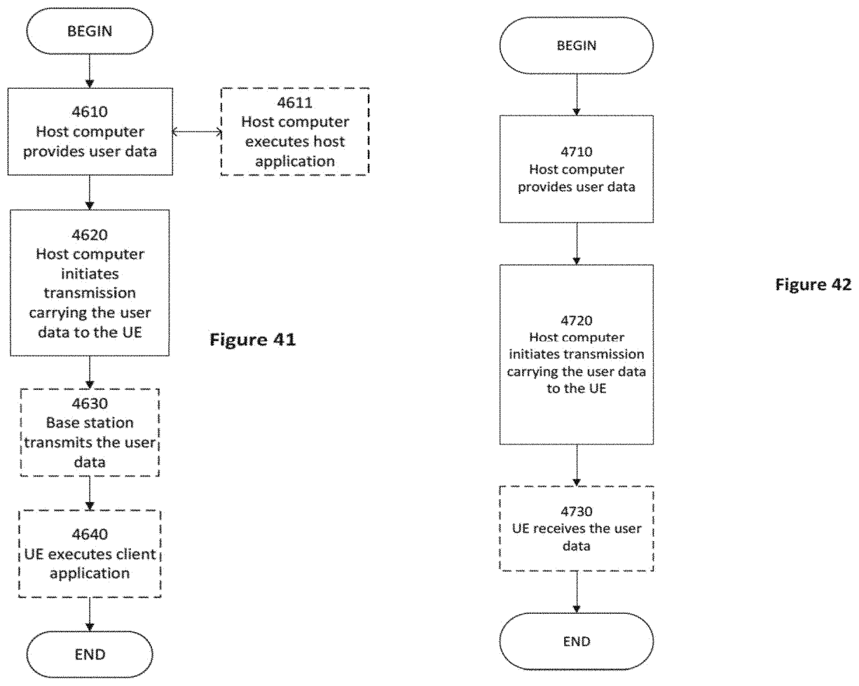

FIG. 41 illustrates methods implemented in a communication system including a host computer, a base station and a user equipment in accordance with some embodiments

FIG. 41 is a flowchart illustrating a method implemented in a communication system, in accordance with one embodiment. The communication system includes a host computer, a base station and a UE which may be those described with reference to FIGS. 39 and 40. For simplicity of the present disclosure, only drawing references to FIG. 41 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

FIG. 42 illustrates methods implemented in a communication system including a host computer, a base station and a user equipment in accordance with some embodiments.

FIG. 42 is a flowchart illustrating a method implemented in a communication system, in accordance with one embodiment. The communication system includes a host computer, a base station and a UE which may be those described with reference to FIGS. 39 and 40. For simplicity of the present disclosure, only drawing references to FIG. 42 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

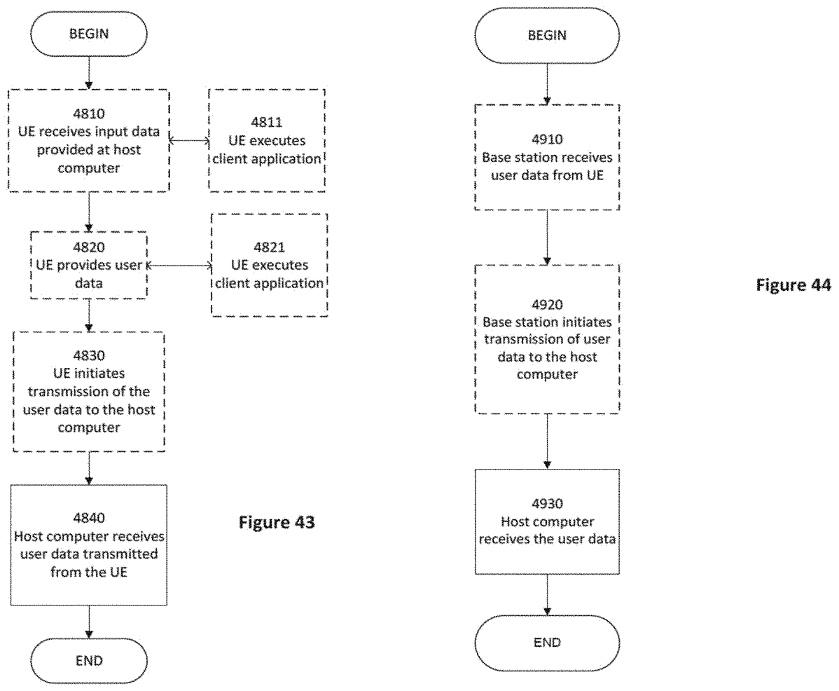

FIG. 43 illustrates methods implemented in a communication system including a host computer, a base station and a user equipment in accordance with some embodiments

FIG. 43 is a flowchart illustrating a method implemented in a communication system, in accordance with one embodiment. The communication system includes a host computer, a base station and a UE which may be those described with reference to FIGS. 39 and 40. For simplicity of the present disclosure, only drawing references to FIG. 43 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

FIG. 44 illustrates methods implemented in a communication system including a host computer, a base station and a user equipment in accordance with some embodiments

FIG. 44 is a flowchart illustrating a method implemented in a communication system, in accordance with one embodiment. The communication system includes a host computer, a base station and a UE which may be those described with reference to FIGS. 39 and 40. For simplicity of the present disclosure, only drawing references to FIG. 44 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 1x RTT | CDMA2000 1x Radio Transmission Technology |
| 3GPP | 3rd Generation Partnership Project |
| 5G | 5th Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH | Ec/No CPICH Received energy per chip |
| | divided by the power density in the band |
| CQI | Channel Quality information |
| C-RNTI | Cell RNTI |
| CSI | Channel State Information |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| E-SMLC | Evolved-Serving Mobile Location Centre |
| ECGI | Evolved CGI |
| eNB | E-UTRAN NodeB |
| ePDCCH | enhanced Physical Downlink Control Channel |
| E-SMLC | evolved Serving Mobile Location Center |
| E-UTRA | Evolved UTRA |
| E-UTRAN | Evolved UTRAN |
| FDD | Frequency Division Duplex |
| FFS | For Further Study |
| GERAN | GSM EDGE Radio Access Network |
| gNB | Base station in NR |
| GNSS | Global Navigation Satellite System |
| GSM | Global System for Mobile communication |
| HARQ | Hybrid Automatic Repeat Request |
| HO | Handover |
| HSPA | High Speed Packet Access |
| HRPD | High Rate Packet Data |
| LOS | Line of Sight |
| LPP | LTE Positioning Protocol |
| LTE | Long-Term Evolution |
| MAC | Medium Access Control |
| MBMS | Multimedia Broadcast Multicast Services |
| MBSFN | Multimedia Broadcast multicast service |
| | Single Frequency Network |
| MBSFN ABS | MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDP | Profile Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| RAN | Radio Access Network |
| RAT | Radio Access Technology |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR |
| | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| UMTS | Universal Mobile Telecommunication System |
| USIM | Universal Subscriber Identity Module |
| UTDOA | Uplink Time Difference of Arrival |
| UTRA | Universal Terrestrial Radio Access |
| UTRAN | Universal Terrestrial Radio Access Network |
| WCDMA | Wide CDMA |
| WLAN | Wide Local Area Network |

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method by a network node comprising:
determining a carrier aggregation, CA, limit for user equipment, UE, configuration with monitoring capability, based on: a downlink, DL-sub-slot structure and/or pattern of a DL slot; a set of overlapping spans across scheduling cells; start and end times for spans across component carriers; and/or spans at least partially overlapping a CA limit window.

2. The method of claim 1, wherein the CA limit is determined for UE configuration for physical downlink control channel, PDCCH, monitoring.

3. The method of claim 1, wherein the UE configuration comprises at least one of: subcarrier spacing, SCS, for PDCCH monitoring; a combination of minimum time (X) separation between the start of two PDCCH monitoring spans and maximum length (Y) of the spans; and number of component carriers configured for PDCCH monitoring.

4. The method of claim 3, wherein the DL-sub-slot structure and/or pattern is determined for each combination (X,Y) and subcarrier spacing, SCS, configuration μ based on PDCCH monitoring span patterns of N_{cells,r16}^{DL,(X,Y),μ} downlink, DL, cells and/or component carriers associated with the combination (X,Y).

5. The method of claim 4, wherein the determination of the DL-sub-slot pattern for the combination (X,Y), comprises generating a bitmap b(l), wherein 0<=l<=13, an where b(l)=1 if symbol l of a slot is the starting symbol of a monitoring span of the relevant component carriers, and b(l)=0 otherwise.

6. The method of claim 5, wherein a first DL sub-slot in the DL-sub-slot pattern begins at the smallest 1 for which b(l)=1, and has duration T symbols, and the next DL-sub-slot in the DL-sub-slot pattern begins at the smallest 1 not included in the previous DL-sub-slot(s) for which b(l)=1.

7. The method of claim 1, wherein the DL-sub-slot structure and/or pattern is fixed for a given combination of the combination and μ {(X,Y), μ} and does not vary with the actual monitoring span pattern of the component carriers, wherein “μ” is the subcarrier spacing, SCS, configuration.

8. The method of claim 1, wherein one DL-sub-slot structure and/or pattern is defined for each combination (X,Y) corresponding to a UE reported capability for Rel-16 PDCCH monitoring regardless of the numerology μ, wherein “μ” is the subcarrier spacing, SCS, configuration.

9. The method of claim 1, wherein a same DL-sub-slot structure and/or pattern is defined for each combination (X,Y) of a given numerology μ, wherein “μ” is the subcarrier spacing, SCS, configuration.

10. The method of claim 1, wherein one or more DL-sub-slot structures and/or patterns are defined for each combination (X,Y) and DL numerology μ, corresponding to a UE reported capability for Rel-16 PDCCH monitoring, wherein “X” is the minimum separation between the start of two PDCCH monitoring spans, and wherein “μ” is the subcarrier spacing, SCS, configuration.

11. The method of claim 1, wherein when the UE is configured with multiple DL cells using Rel-16 PDCCH monitoring capability associated with combination (X,Y), the same DL-sub-slot structure and/or pattern corresponding to combination (X,Y) is applied to all the scheduling cells associated with the combination (X,Y).

12. The method of claim 1, wherein when the UE is configured with a number of DL cells for all subcarrier spacing, SCS, Σ_{μ=0}¹ N_{cells,r16}^{DL,μ} smaller than or equal to a UE reported capability N_{cells}^{cap-r16}, the method does not require the UE to monitor more than M_{PDCCH}^{max,(X,Y),μ} PDCCH candidates per span or C_{PDCCH}^{max,(X,Y),μ} non-overlapped control channel elements, CCEs, per span on the active DL one or more BandWidth Parts, BWPs of one or more scheduling cells from the N_{cells,r16}^{DL,(X,Y),μ} downlink cells.

13. The method of claim 1, wherein when the UE is configured with a number of DL cells for all SCS, Σ_{μ=0}¹ N_{cells,r16}^{DL,μ} larger than a UE reported capability N_{cells}^{cap-r16}, the method does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans present in the same DL-sub-slot across the active DL BWP(s) of scheduling cell(s) from N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein the span is present in a DL-sub-slot if at least one symbol of the span is in the DL-sub-slot or overlaps with the DL-sub-slot.

14. The method of claim 1, wherein when the UE is configured with a number of DL cells for all SCS, Σ_{μ=0}¹ N_{cells,r16}^{DL,μ} larger than a UE reported capability N_{cells}^{cap-r16}, the method does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans starting in the same DL-sub-slot across the active DL at least one BandWidth Part, BWP, of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with subcarrier spacing, SCS, configuration j, and wherein the span is starting in a DL-sub-slot if the first symbol of the span is in the DL-sub-slot.

15. The method of claim 1, wherein when the UE is configured with a number of DL cells for all SCS, Σ_{μ=0}¹ N_{cells,r16}^{DL,μ} larger than a UE reported capability N_{cells}^{cap-r16}, the method does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans present in the same DL-sub-slot across the active DL at least one BandWidth Parts, BWP, of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with subcarrier spacing, SCS, configuration j, and wherein a span is present in a DL-sub-slot if at least one symbol of the span is in the DL-sub-slot or overlaps with the DL-sub-slot.

16. The method of claim 1, wherein when the UE is configured with a number of DL cells for all SCS, Σ_{μ=0}¹ N_{cells,r16}^{DL,μ} larger than a UE reported capability N_{cells}^{cap-r16}, the method does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·C_{PDCCH}^{max,(X,Y),μ}·N_{cells,rel16}^{DL,(X,Y),μ}/Σⱼ₌₀¹(N_{cells,r16}^{DL,j}) [symbol] non-overlapped CCEs for any set of spans starting in the same DL-sub-slot across the active DL at least one BandWidth Parts, BWPs, of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with SCS configuration j, and wherein a span is starting in a DL-sub-slot if the first symbol of the span is in the DL-sub-slot.

17. The method of claim 1, wherein when the UE is configured with a number of DL cells for all subcarrier spacing, SCS, Σ_{μ=0}¹ N_{cells,r16}^{DL,μ} larger than a UE reported capability N_{cells}^{cap-r16}, the method does not require the UE to monitor more than M_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] PDCCH candidates or C_{PDCCH}^{total,(X,Y),μ}= [symbol] N_{cells}^{cap-r16}·M_{PDCCH}^{max,(X,Y),μ}·N_{cells,rel16}^{DL,(X,Y),μ}/Σⱼ₌₀¹(N_{cells,r16}^{DL,j}) [symbol] non-overlapped control channel elements, CCEs, for any set of spans ending in the same DL-sub-slot across the active DL at least one BandWidth Part, BWP, of at least one scheduling cell from the N_{cells,r16}^{DL,(X,Y),μ} downlink cells with at most one span per scheduling cell for each set, wherein N_{cells,r16}^{DL,j} is a number of configured cells using Rel-16 PDCCH monitoring capability with subcarrier spacing, SCS, configuration j, and wherein a span is ending in a DL-sub-slot if at least the last symbol of the span is in the DL-sub-slot.

18.-27. (canceled)

28. A method by a user equipment, UE, comprising:
during physical downlink control channel, PDCCH, monitoring, dropping a PDCCH candidate when a total number of configured PDCCH candidates or non-overlapped control channel elements, CCEs, in a set of spans on a primary cell or primary secondary cell exceeds a per-span limit or exceeds a carrier aggregation, CA, limit.

29. (canceled)

30. A user equipment, UE, configured to:
during physical downlink control channel, PDCCH, monitoring, drop a PDCCH candidate when a total number of configured PDCCH candidates or non-overlapped control channel elements, CCEs, in a set of spans on a primary cell or primary secondary cell exceeds a per-span limit or exceeds a carrier aggregation, CA, limit.

31. A network node configured to:
determine a carrier aggregation, CA, limit for user equipment, UE, configuration with monitoring capability, based on: a downlink, DL-sub-slot structure and/or pattern of a DL slot; a set of overlapping spans across scheduling cells; start and end times for spans across component carriers; and/or spans at least partially overlapping a CA limit window.

32. The network node of claim 31, wherein the CA limit is determined for UE configuration for physical downlink control channel, PDCCH, monitoring.
